(19) United States
(12) Patent Application Publication
(10) Pub. No.: US 2026/0081144 A1
(43) Pub. Date: Mar. 19, 2026

(54) NEGATIVE ELECTRODE FOR A LITHIUM BATTERY

(71) Applicant: Rutgers, The State University of New Jersey, New Brunswick, NJ (US)

(72) Inventors: Glenn G. Amatucci, Peapack, NJ (US); Anna B. Halajko, New Brunswick, NJ (US); Fadwa Badway, New Brunswick, NJ (US); Rachael Behler, New Brunswick, NJ (US)

(21) Appl. No.: 19/393,268

(22) Filed: Nov. 18, 2025

Related U.S. Application Data
(63) Continuation of application No. PCT/US24/31039, filed on May 24, 2024.
(60) Provisional application No. 63/468,648, filed on May 24, 2023.

(51) Int. Cl. H01M 4/38; H01M 4/04; H01M 10/0525

(52) U.S. Cl. CPC H01M 4/382; H01M 4/0423; H01M 10/0525

(57) ABSTRACT

A battery includes a housing, a positive electrode in the housing, and a negative electrode in the housing. The negative electrode comprises an alloy. The alloy comprises lithium, magnesium, and silver at a period during charging or discharging of the battery. The battery includes an electrolyte in the housing. The electrolyte configured to conduct ionic current between the positive electrode and the negative electrode.

### CROSS-REFERENCE TO RELATED APPLICATIONS

This application is a Continuation Application relating to and claiming the benefit of commonly-owned, co-pending PCT International Application No PCT/US2024/031039, filed May 24, 2024, which claims priority to U.S. Provisional Patent Application 63/468,648, titled “Negative Electrode for a Battery,” filed May 24, 2023, the content of each of the forgoing are herein incorporated by reference herein in its entirety.

### FIELD

The present invention is directed to a battery, and, more particularly, to a negative electrode for a lithium battery.

### BACKGROUND

In a known Li-ion battery, the battery includes a positive electrode and a negative electrode, and the negative electrode includes graphite or some form of carbon. In some known Li-ion batteries, the negative electrodes include lithium alloys, such as LiₓSi, LiₓGe, LiₓAl, LiₓSn. In some known batteries, the electrodes plate and strip Li metal every charge and discharge cycle of the battery, respectively.

### SUMMARY

In some embodiments, a battery includes a housing; a positive electrode in the housing; a negative electrode in the housing, wherein the negative electrode comprises an alloy, wherein the alloy comprises lithium, magnesium, and silver at a period during charging or discharging of the battery; and an electrolyte in the housing, the electrolyte configured to conduct ionic current between the positive electrode and the negative electrode.

In some embodiments, a material of the positive electrode does not include lithium in its atomic structure as assembled in the housing.

In some embodiments, a material of the positive electrode contains lithium in its atomic structure as assembled in the housing.

In some embodiments, a total weight percent of the lithium, magnesium, and silver in the alloy is at least 50% of a total weight of the alloy.

In some embodiments, a material of the negative electrode has a crystal structure as determined by XRD to be consistent with Li₂AgMg.

In some embodiments, a material of at least a portion of the negative electrode has a crystal structure as determined by XRD to be consistent with AgMg, wherein the lithium is added to form a ternary alloy comprising the lithium, magnesium, and silver during the charging and discharging of the battery.

In some embodiments, a material of at least a portion of the negative electrode comprises an alloy intermetallic of Mg and Ag, and wherein the lithium is added to form a ternary alloy comprising the lithium, magnesium, and silver during operation of the battery.

In some embodiments, the electrolyte comprises lithium, fluoride, or a solid-state electrolyte.

In some embodiments, the negative electrode comprises graphite.

In some embodiments, the positive electrode comprises at least one of a metal fluoride, sulfur, or metal sulfide.

In some embodiments, the positive electrode comprises at least one of a metal cobalt, nickel, iron, manganese.

In some embodiments, the positive electrode comprises iron fluoride or bismuth fluoride.

In some embodiments, the alloy has a crystal structure represented by at least an X-ray diffraction peak corresponding to a d spacing of approximately 3.6 to 4.2 Angstroms.

In some embodiments, at least a second X-ray diffraction peak corresponds to a d spacing of approximately 3.1 to 3.5 Angstroms.

In some embodiments, the battery comprises a lithium-ion battery or a solid-state lithium battery.

In some embodiments, a battery includes a housing; a positive electrode in the housing; a negative electrode in the housing; a current collector in the housing; a separator in the housing; an electrolyte in the housing; and an alloy, wherein the alloy comprises lithium, magnesium, and silver, wherein the alloy is on at least one of the negative electrode, the separator, and the current collector.

In some embodiments, a method includes obtaining a housing; disposing a positive electrode in the housing; disposing a negative electrode in the housing; depositing an alloy on the negative electrode, separator, or solid electrolyte, wherein the alloy comprises lithium, magnesium, and silver; and disposing an electrolyte in the housing, the electrolyte configured to conduct current between the positive electrode and the negative electrode.

In some embodiments, the depositing comprises depositing by physical vapor deposition.

In some embodiments, the alloy is an alloy film, and wherein the depositing comprises depositing the alloy film.

In some embodiments, a total weight percent of the lithium, magnesium, and silver in the alloy is at least 50% of a total weight of the alloy.

### BRIEF DESCRIPTION OF THE DRAWINGS

This section refers to the drawings that form a part of this disclosure, and which illustrate some of the embodiments of structure, materials, and/or methods of the present invention described herein.

FIG. 1 are graphs showing the results in accordance with Example 1, for Li vs. NbPO₅ electrodes, in accordance with some embodiments of the invention.

FIG. 2 are graphs showing the results in accordance with Example 2, for Li:MG vs. NbPO₅ electrodes, in accordance with some embodiments of the invention.

FIG. 3A are graphs showing the results in accordance with Example 3A, for 7Li:Mg:xAg Ternary Alloys vs. NbPO₅ electrodes, in accordance with some embodiments of the invention.

FIG. 3B is a graph showing the results in accordance with Example 3B, for 7Li:1Mg:xAg Ternary Alloys vs. NbPO₅ electrodes, in accordance with some embodiments of the invention.

FIG. 4A are graphs showing the results in accordance with Example 4A, for 10Li:1Mg:xAg Ternary Alloys vs. NbPO₅ electrodes, in accordance with some embodiments of the invention.

FIG. 4B is a graph showing the results in accordance with Example 4B, for 10Li:1Mg:xAg Ternary Alloys vs. NbPO₅ electrodes, in accordance with some embodiments of the invention.

FIG. 5A are graphs showing the results in accordance with Example 5A, for 13Li:1Mg:xAg Ternary Alloys vs. NbPO₅ electrodes, in accordance with some embodiments of the invention.

FIG. 5B is a graph showing the results in accordance with Example 5B, for 13Li:1Mg:xAg Ternary Alloys vs. NbPO₅ electrodes, in accordance with some embodiments of the invention.

FIG. 6A are graphs showing the results in accordance with Example 6A, for various electrodes, in accordance with some embodiments of the invention.

FIG. 6B is a graph showing the results in accordance with Example 6B, for various electrodes, in accordance with some embodiments of the invention.

FIG. 7A are graphs showing the results in accordance with Example 7A, for various electrodes, in accordance with some embodiments of the invention.

FIG. 7B is a graph showing the results in accordance with Example 7B, for various electrodes, in accordance with some embodiments of the invention.

FIG. 8A are graphs showing the results in accordance with Example 8A, for various electrodes, in accordance with some embodiments of the invention.

FIG. 8B is a graph showing the results in accordance with Example 8B, for various electrodes, in accordance with some embodiments of the invention.

FIG. 9A are graphs showing the results in accordance with Example 9A, for various electrodes, in accordance with some embodiments of the invention.

FIG. 9B is a graph showing the results in accordance with Example 9B, for various electrodes, in accordance with some embodiments of the invention.

FIG. 10A are graphs showing the results in accordance with Example 10A, for various electrodes, in accordance with some embodiments of the invention.

FIG. 10B is a graph showing the results in accordance with Example 10B, for various electrodes, in accordance with some embodiments of the invention.

FIG. 11A are graphs showing the results in accordance with Example 11A, for various electrodes, in accordance with some embodiments of the invention.

FIG. 11B is a graph showing the results in accordance with Example 11B, for various electrodes, in accordance with some embodiments of the invention.

FIG. 12A are graphs showing the results in accordance with Example 12A, for various electrodes, in accordance with some embodiments of the invention.

FIG. 12B is a graph showing the results in accordance with Example 12B, for various electrodes, in accordance with some embodiments of the invention.

FIGS. 13-39 are graphs showing results related to evaluation of electrodes, in accordance with some embodiments of the invention.

### DETAILED DESCRIPTION

In some embodiments, the present invention provides an alloy structure that offers exceptional stability and benefit to the stabilization of Li-alloy and Li-metal/alloy hybrid negative electrodes.

In some embodiments, the alloy is referred to as a ternary alloy, including at least Li, Mg, and Ag, with or without additional materials. In some embodiments, the ternary alloy results in exceptional and unexpected performance relative to that of other alloys, and especially alloys of LiₓMg and LiₓAg. In some embodiments, a crystal structure is formed with extremely high amounts of Li and low amounts of Ag, for example as in Li₇MgAg_{0.125}. In some embodiments, the crystal structure is configured as a negative electrode material in thin film form, and functions to provide high capacity. In some embodiments, the unexpected result allows in eliminating a binder, carbon black, and/or other components utilized in the fabrication of the negative electrode, further decreasing the weight and volume of the other components used in the negative electrode, and/or the battery.

In some embodiments, comparative examples of the efficacy of this approach in lithium batteries using two different types of positive electrodes is provided. In some embodiments, an improvement relative to the use of LiₓMg or LiₓAg alloys of different structures is shown.

As used herein, mAh refers to the electrochemical cell capacity measured, and mAh/g is the capacity as normalized to the weight of the active electrode material utilized in the positive electrode.

As used herein, a separator refers to a non-electronically conducting material that separates positive and negative electrodes from being in electronic contact while maintaining ionic conductivity. The separator is porous thus allowing ionically-conducting liquid electrolyte to be imbibed into the material, or the separator is a solid-state ionic conductor itself of either polymer and/or an inorganic composition.

In accordance with the following described example, the comparative non-lithium battery has the following parameters:
Positive electrode: Beta Nb_{0.98}Ta_{0.02}PO₅
Positive Electrode composition: 70% active, 20% Pvdf/HFP, 10% SP
Typical Electrode Capacity: 1.70 mAh
Positive electrode diameter: 0.79 cm=0.50 cm²
Electrolyte: LiPF₆ EC:DMC (baseline, no additives)
Volume of electrolyte: 0.050 ml
Voltage: 1.65-2.8V
Charge: 10 mA/g positive
Discharge: 15 mA/g positive
Separator: One Celgard approximately 25 micron thick
Negative Electrode Deposition:
Substrate: Cu 110 99.9% pure, oxygen 0.04, trace Ag
Substrate prep: Acetone, 2X15 min, dry 40° C.
Cu diameter: 12.3 mm
Li/Mg/Ag Deposition Diameter: 11 mm=0.95 cm²
Baseline Li vs. NbPO₅

### Example 1

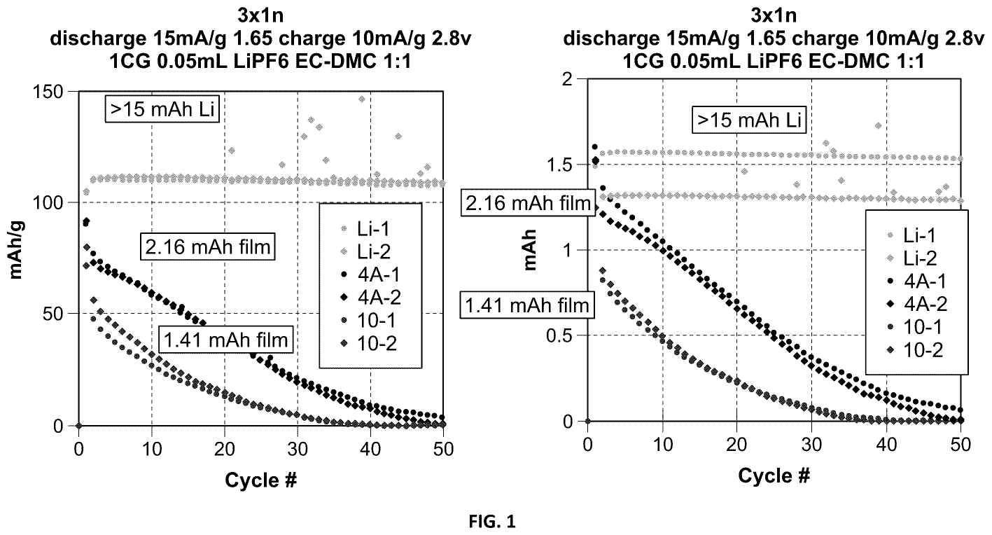

As set forth in Example 1, with reference to FIG. 1, Li metal was deposited on 0.95 cm² Cu disks to achieve 1.41 mAh and 2.16 mAh electrodes, respectively. These electrodes were also compared with 150 micron Li metal disks that had a capacity in excess of 15 mAh. All three Li electrodes were fabricated, in duplicate into electrochemical cells vs. NbPO₅ based positive electrodes as outlined in experiment. As expected, the thick, 150 micron Li metal disk cycled very well. However, the large excess of Li metal prevents this from being a practical pathway for high energy density cells. The <5 mAh Li metal disks reveal much decay with cycle number and is worst for the thinner and least capacity 1.4 mAh film. All cells were formed in duplicates, as shown, and reveal similar behavior. Without being limited by theory, it appears that the cells do not fail due to Li dendrite formation, but rather by Li consumption via deleterious reaction with the electrolyte. As such, the Li electrodes with the least reserve of Li metal fail the quickest. This data exemplifies the need for negative electrodes with much increased stability.

Baseline LiMg vs. NbPO₅ Positive electrode

### Example 2

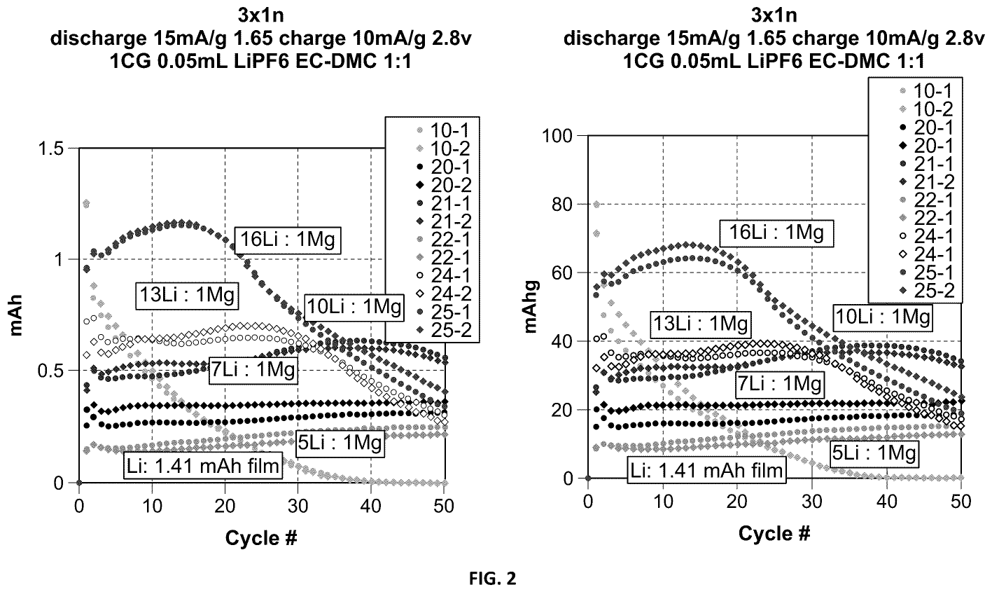

As set forth in Example 2, with reference to FIG. 2, Li:Mgₓ metal was codeposited by physical vapor deposition on 0.95 cm² Cu disks in decreasing Li:Mg stoichiometric ratios: 100:0, 16:1, 13:1, 10:1, 7:1, 5:1. In order to compare all electrodes properly, all electrodes were deposited using 1.6 g of Li metal and Mg amounts were increased to the appropriate stoichiometric ratios as noted above. All Li:Mg electrodes were fabricated, in duplicate, into electrochemical cells vs. NbPO₅ based positive electrodes as outlined in experimental. As noted in Example 1, the deposited Li metal film (100:0, 1.41 mAh), had high initial capacity, but failed rapidly. Introducing a small amount of Mg (16:1) resulted in an extreme improvement in cycling but with fade developing after approximately 25 cycles. However, sample of 7:1 resulted in excellent cycling stability, albeit at lower capacities. This trend of exceptional cycling stability, but decreasing capacity continued for increasing Mg contents. A ratio of 7:1-10:1 displayed the best combination of cycling stability and capacity.

7Li:Mg:xAg Ternary Alloys vs. NbPO₅ Positive electrode

### Example 3A

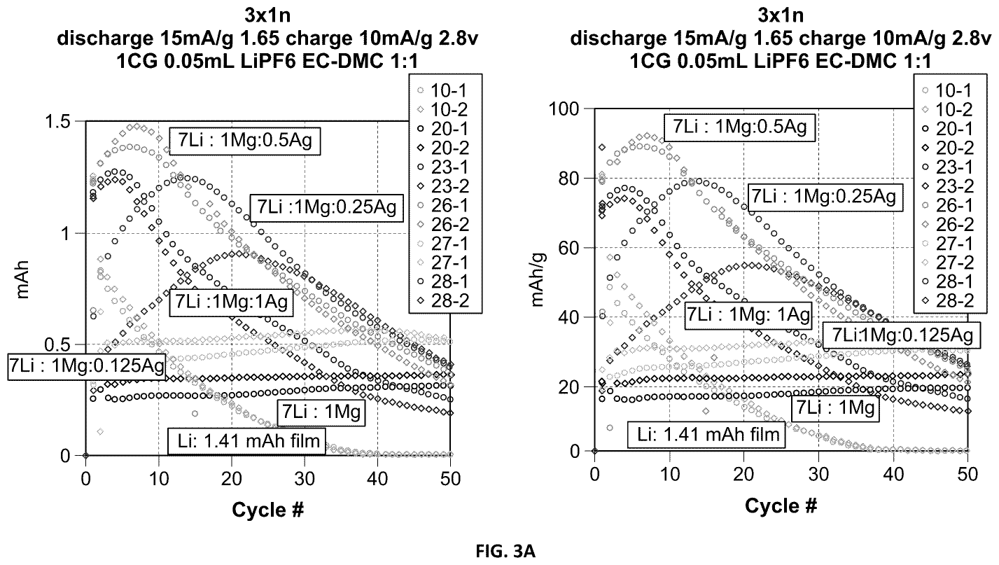

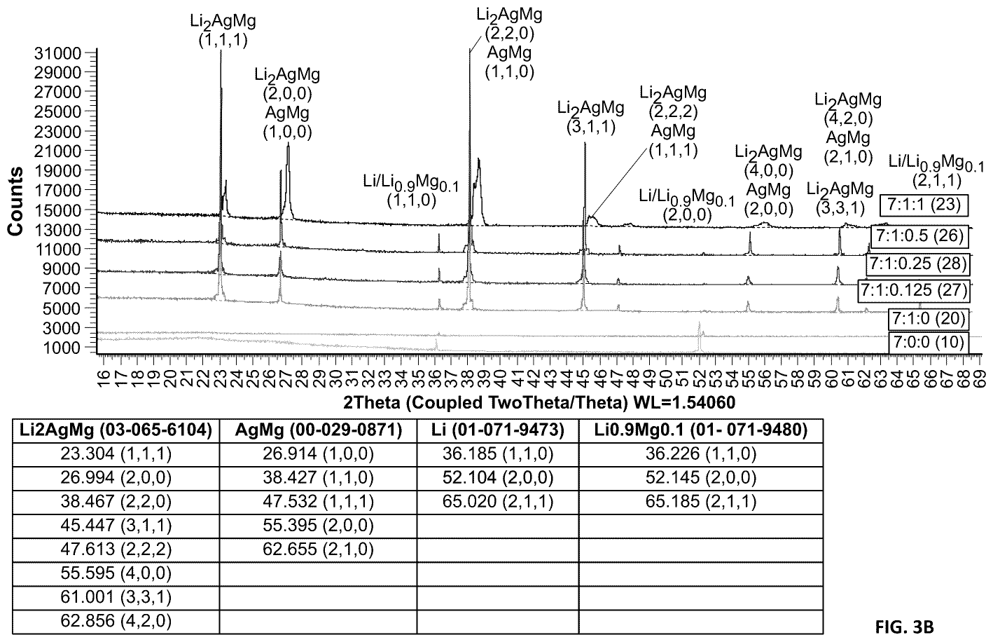

With respect to Example 3A, with reference to FIG. 3A, similar to as in Example 2, the implementation of Li:Mg alloys resulted in a marked stabilization of the negative Li metal reaction. However, it was observed, that this was done at the cost of reduced capacity, below that of the theoretical capacity made available by the Li metal available in the film. It appears that this may be due to transport limitations. To attempt to increase the achievable capacity, small amounts of Ag metal was introduced into the compositions because of its high electronic conductivity and its ability to alloy with Li metal at low voltages. Li:Mg:Ag metal was codeposited by physical vapor deposition on 0.95 cm² Cu disks in increasing Ag Li:Mg:Ag stoichiometric ratios based on the 7Li:1Mg ratio that was identified as being one of the better ratios in Example 2:100:0:0, 7:1:0, 7:1:0.125, 7:1:0.500, 7:1:1.00. To compare all electrodes properly, all electrodes were deposited using 1.6 g of Li metal and Mg and Ag amounts were increased to the appropriate stoichiometric ratios as noted above. All Li:Mg:Ag electrodes were fabricated, in duplicate, into electrochemical cells vs. NbPO₅ based positive electrodes as outlined in experimental. As noted in Example 1, the deposited Li metal film (100:0, 1.41 mAh), had high initial capacity, but failed rapidly. Introducing a small amount of Mg (7:1) resulted in in excellent cycling stability, albeit at lower capacities. The addition of a remarkably small amount of Ag in the ratio of 7:1:0.125 resulted in almost a 50% increase in capacity while retaining capacity retention. Increasing the amount of Ag to a ratio of 7:1:0.5 resulted in a 400% increase of capacity although an increase in capacity fade was observed. In short, the addition of Ag resulted in a remarkable improvement of the electrochemical performance of the alloy. However, it appears that a mechanism that went beyond just the addition of Ag may be in play. Therefore, the alloy was examined by X-ray diffraction.

7Li:1Mg:xAg Ternary Alloys vs. NbPO₅ Positive electrode

### Example 3B

As shown in Example 3B, with reference to FIG. 3B, as may be seen in the XRD diffractograms of the negative electrodes of utilized in Example 3A, there is a clear and systematic improvement of capacity and cycle life with presence of the “Li₂AgMg” like phase present in the diffractograms relative to other phases such as LiMgₓ and AgMg. It was unexpected that such a small amount of Ag induced the stabilization of this structure which is usually reserved for higher amounts of Ag. It is not clear that such a phase has been examined for use in lithium batteries. However, testing establishes that it has extraordinary properties.

10Li:1Mg:xAg Ternary Alloys vs. NbPO₅ Positive electrode

### Example 4A

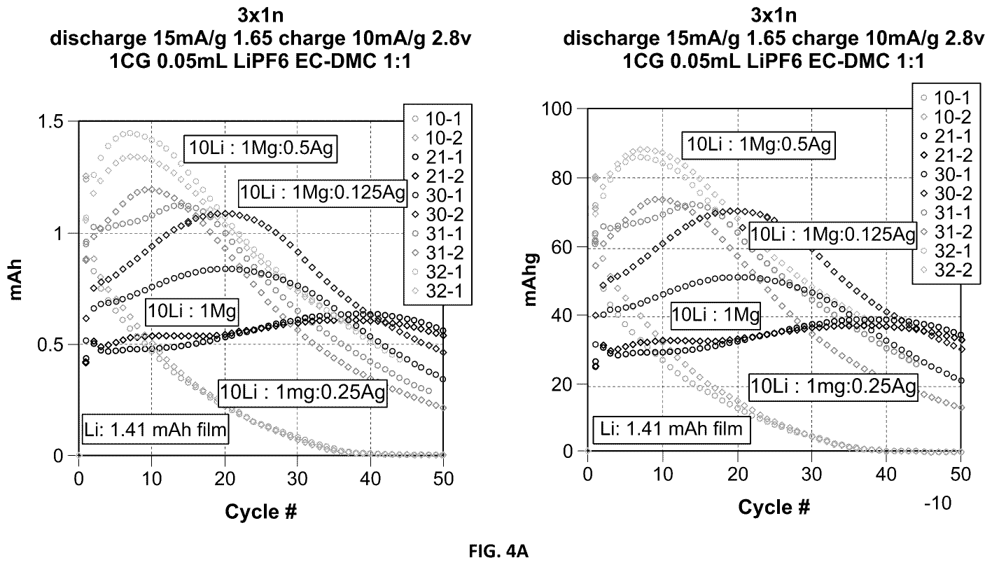

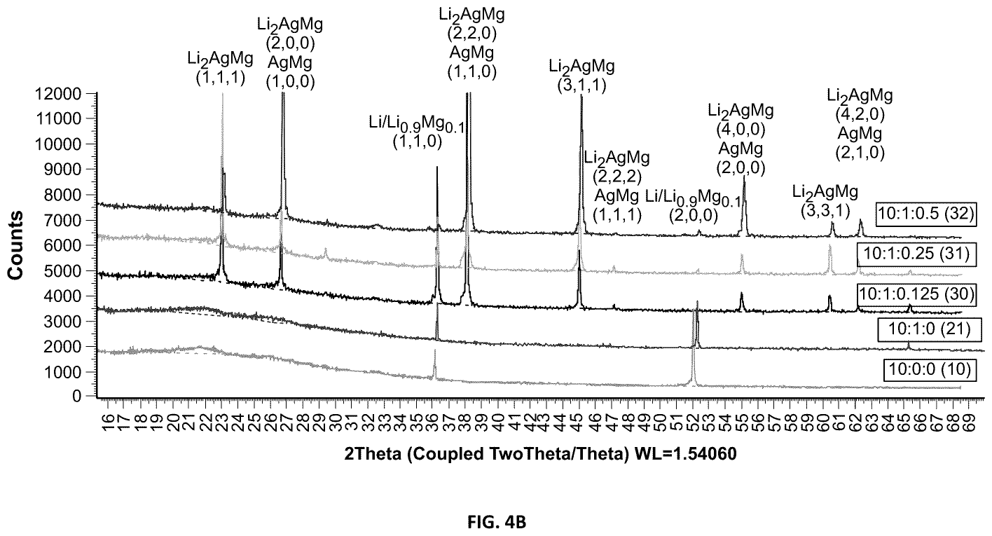

With reference to FIG. 4A, Example 4A is based on a similar approach of co-depositing Li:Mg:Ag metal to improve the electrochemical performance of 7Li:1Mg alloys was also developed for the 10Li:1 Mg ratio electrodes that were deemed desirable in Example 2. 10Li:1 Mg:Agₓ ratios were codeposited by physical vapor deposition on 0.95 cm² Cu disks in increasing Ag content: 100:0:0, 10:1:0, 10:1:0.125, 10:1:0.250, and 10:1:0.500. To compare all electrodes properly, all electrodes were deposited using 1.6 g of Li metal and Mg and Ag amounts were increased to the appropriate stoichiometric ratios as noted above. All Li:Mg:Ag electrodes were fabricated, in duplicate, into electrochemical cells vs. NbPO₅ based positive electrodes as outlined in experimental. As noted in Example 1, the deposited Li metal film (100:0, 1.41 mAh), had high initial capacity, but failed rapidly. Introducing a small amount of Mg (10:1) resulted in in excellent cycling stability, albeit at lower capacities. Again, the addition of a remarkably small amount of Ag in the ratio of 7:1:0.125 resulted in almost a 30-40% increase in capacity while retaining capacity retention. Increasing the amount of Ag to a ratio of 7:1:0.5 resulted in a >100% increase of capacity although an increase in capacity fade was observed. The addition of Ag resulted in a remarkable improvement of the electrochemical performance of the alloy.

10Li:1Mg:xAg Ternary Alloys vs. NbPO₅ Positive electrode

### Example 4B

With respect to Example 4B, and with reference to FIG. 4B, as may be seen in the XRD diffractograms of the negative electrodes utilized in Example 4A, there is a clear and systematic improvement of capacity and cycle life with presence of the “Li₂AgMg” like phase present in the diffractograms relative to other phases such as LiMgₓ. Further confirming the importance of this phase as first demonstrated in Example 3A.

13Li:1Mg:xAg Ternary Alloys vs. NbPO₅ Positive electrode

### Example 5A

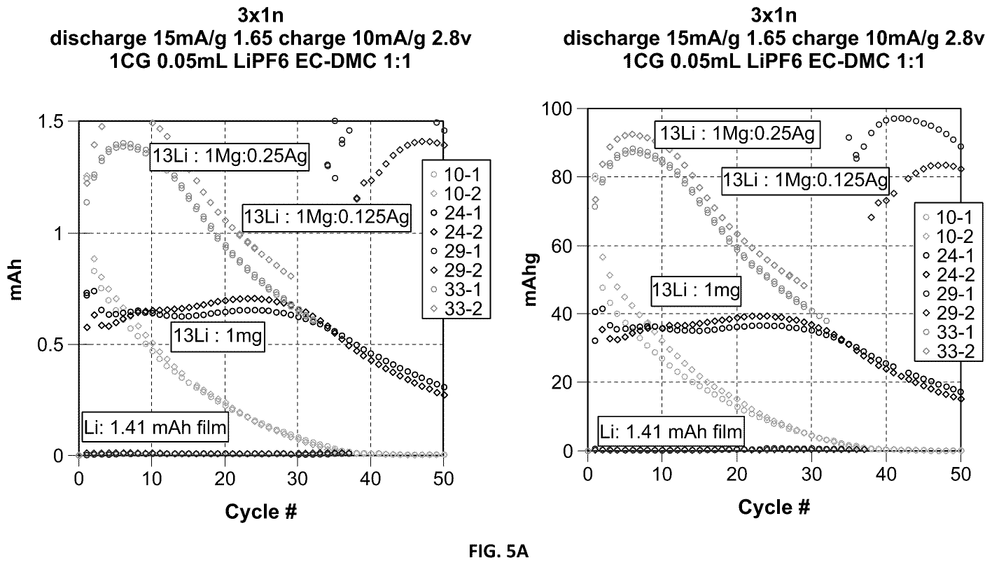

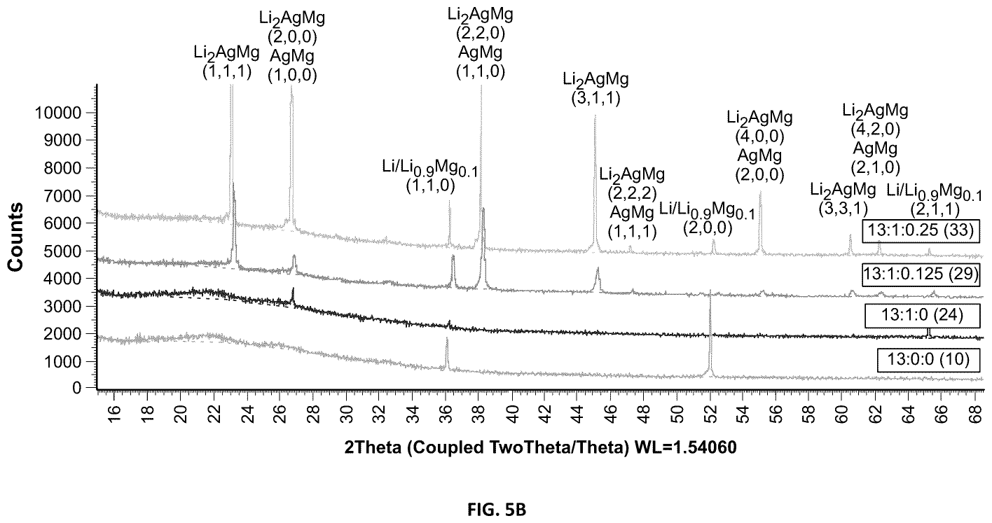

In Example 5A, with reference to FIG. 5A, a similar approach of co-depositing Li:Mg:Ag metal to improve the electrochemical performance of 7Li:1Mg and 10Li:1Mg alloys was also developed for the 13Li:1Mg ratio electrodes that were deemed desirable in Example 2. 13:1:Agₓ ratios were codeposited by physical vapor deposition on 0.95 cm² Cu disks in increasing Ag Li:Mg:Ag stoichiometric ratios: 100:0:0, 13:1:0, 13:1:0.125, and 13:1:0.250. In order to compare all electrodes properly, all electrodes were deposited using 1.6 g of Li metal, and Mg and Ag amounts were increased to the appropriate stoichiometric ratios as noted above. All Li:Mg:Ag electrodes were fabricated, in duplicate, into electrochemical cells vs. NbPO₅ based positive electrodes as outlined in experimental. As noted in Example 1, the deposited Li metal film (100:0, 1.41 mAh), had high initial capacity, but failed rapidly. Introducing a small amount of Mg (13:1) resulted in much improved cycling stability, albeit at lower capacities. Again, the addition of a remarkably small amount of Ag in the ratio of 7:1:0.250 resulted in almost a 100% increase in capacity, with an increase in capacity fade observed. In short, the addition of Ag resulted in a remarkable improvement of the electrochemical performance of the alloy. However, again, a mechanism beyond solely the addition of Ag may be at least partly responsible.

13Li:1Mg:xAg Ternary Alloys vs. NbPO₅ Positive electrode

### Example 5B

With respect to Example 5B, with reference to FIG. 5B, as may be seen in the XRD diffractograms of the negative electrodes of utilized in Example 5A, there is a clear and systematic improvement of cycle life with the purity of the “Li₂AgMg” like phase present in the diffractograms relative to other phases. Indeed, the purest sample of 13:1:0.25 resulted in the best capacity/cycling performance, while the other phases became systematically worse with decreasing purity and the increasing presence of deleterious LiMgₓ phase.

Alloys of this invention efficacy vs. LiCoO₂ Positive electrode

The previous Examples 1-5B utilized a positive electrode (NbPO₅ based) which did not contain Li within its structure. Therefore, all Li is supplied by the negative electrode of this invention to insert within its crystal structure during the first discharge of the battery. This configuration may be of high importance for the lithium ion batteries of the future which have positive electrodes of especially high energy density. In the majority of the present generation lithium batteries the positive electrode has Li present in its crystal structure which is then removed during the first charge and reacted with the negatives electrode. The negative electrode of use in today's Li-ion batteries is typically graphite which is of very low capacity. It is desirable for the Li that is removed from the positive electrode to be plated as Li-metal or reacted with an alloy to affords exceptional energy density of the battery. However, in most cases this results in very poor cycling efficiency, even if it is placed on a small amount of Li metal already present. This may be largely due to deleterious reactions between the freshly plated Li and the electrolyte. Based on the very positive results we have observed for the non-lithiated positive electrode, we have investigated the use of lithium containing layered compounds used in present day Li batteries to observe the efficacy of the Li:Mg:Ag ternary compositions.

### Example 6A

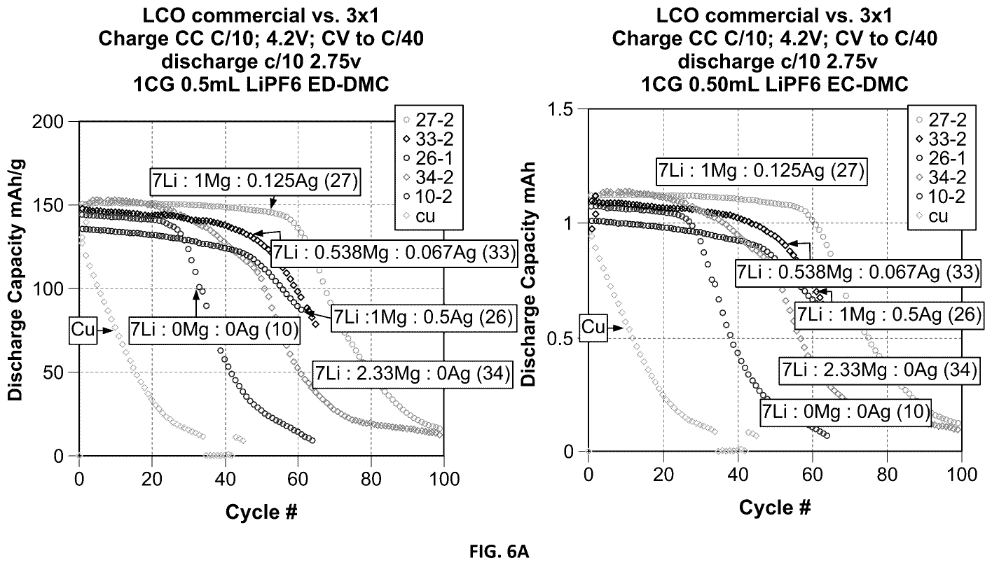

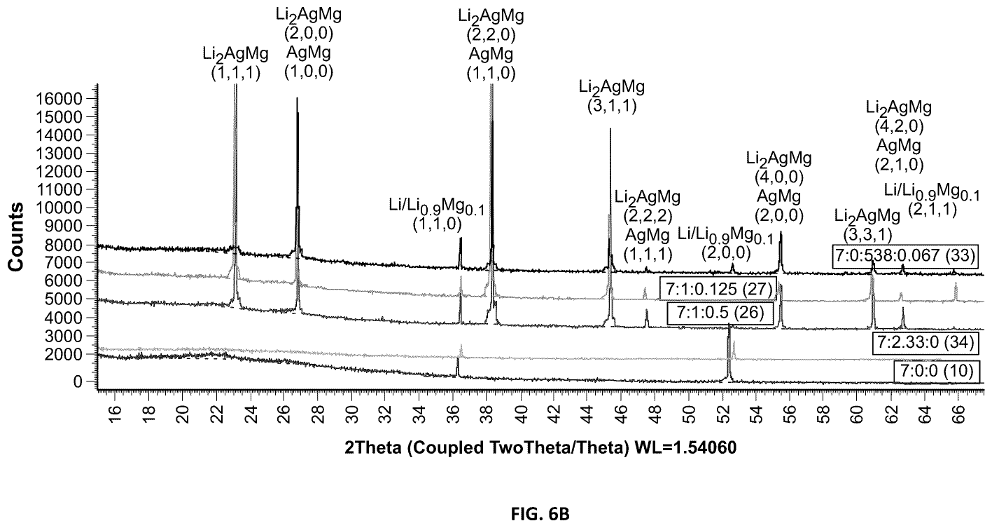

In Example 6A, with reference to FIG. 6A, a positive electrode comprised of LiCoO₂ formed into an electrode (15.06 mg/cm² LiCoO₂; 0.495 cm²=about 1.10 mAh) was placed into electrochemical cells similar to previous experiments, and the positive electrode was started on charge and subsequently cycled in 1M LiPF₆ EC: DMC electrolyte. The following Li:Mg:Ag negative electrode were prepared and fabricated into duplicate cells vs. LiCoO₂ electrodes 0:0:0, 7:0:0, 7:2.33:0, 7:0.538:0.067, 7:1:0.125, and 7:1:0.50. As may be seen the use of no Li at the negative (Cu) results in very poor performance which is only mildly improved by the pure Li film. Adding Mg to the alloy (7:2.33:0) improves the cycling stability further, but the alloy of 7:1:0.125 with a very small amount of Ag results in a very distinct improvement of >100% cycling stability and also improved capacity vs. that of the pure Li film and 50% improvement over the binary Li:Mg alloy. Therefore demonstrating this alloy's exceptional properties vs. pre-lithiated positive electrode compounds also.

Alloys of this invention efficacy vs. LiCoO₂ Positive electrode

### Example 6B

With respect to Example 6B, and with reference to FIG. 6B, as may be seen in the XRD diffractograms of the negative electrodes of utilized in Example 6, there is a clear and systematic improvement of cycle life with the purity of the “Li₂AgMg” like phase present in the diffractograms relative to other phases. Indeed, the purest sample of 7:1:0.125 resulted in the best cycling performance while the other phases became systematically worse with decreasing purity and the increasing presence of deleterious LiMgₓ phase.

Various Binary Alloys: Comparison with Ternary vs. LiCoO₂ Positive electrode

### Example 7A

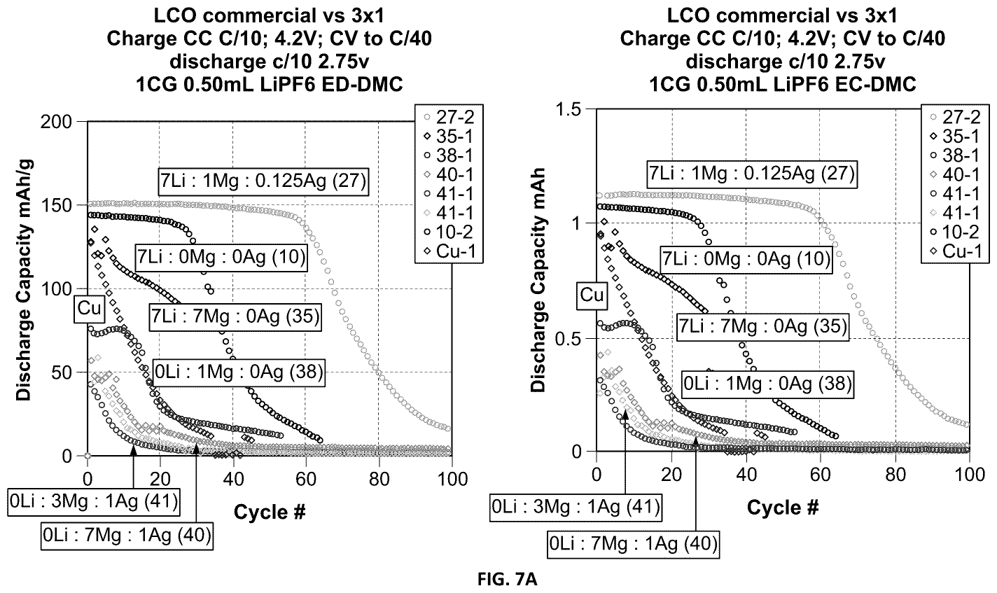

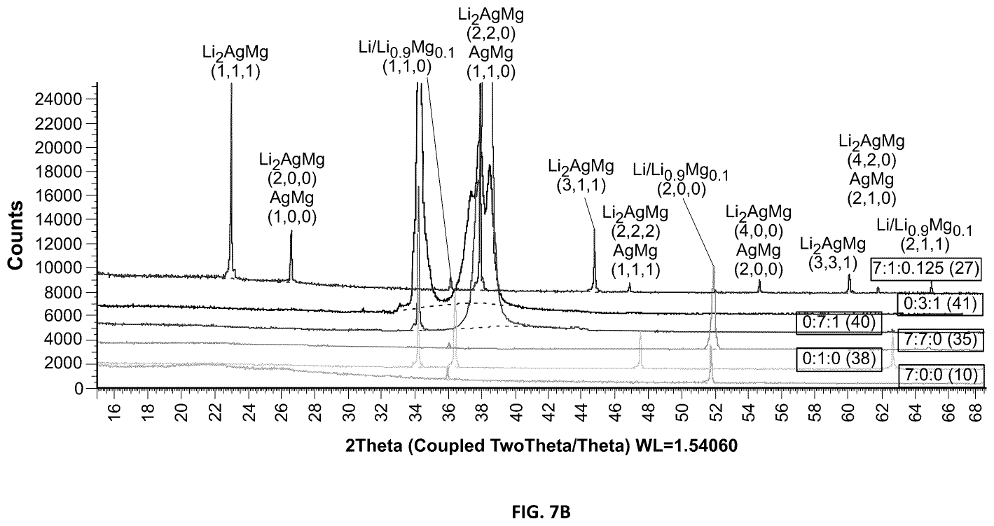

In Example 7A, with reference to FIG. 7A, battery cells were fabricated similarly to Example 6A, but with an exploration of a wider variety of controls as the negative electrode to further exemplify the efficacy of the ternary composition Li:Mg:Ag. This example clearly shows that the three elemental components may result in the exceptional stability of the ternary (7:1:0.125 in this case) in its electrochemical properties.

Various Binary Alloys: Comparison with Ternary vs. LiCoO₂ Positive electrode

### Example 7B

With reference to Example 7B, and FIG. 7B, as may be seen in the XRD diffractograms of the negative electrodes of utilized in Example 7A, there is a clear and distinct improvement of cycle life with the development of the “Li₂AgMg” like phase present in the diffractogram of composition 7:1:0.125 relative to all the other compositions showing Bragg reflections associated with the LiMgₓ phase, pure lithium and AgₓMg phases.

Li Equivalent Cycling Samples vs. LiCoO₂ Positive electrode

### Example 8A

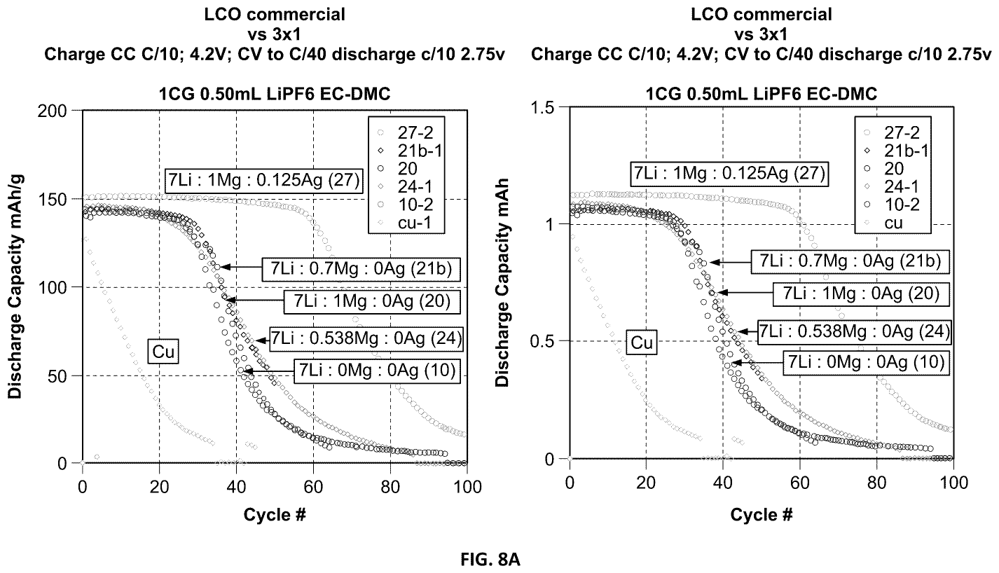

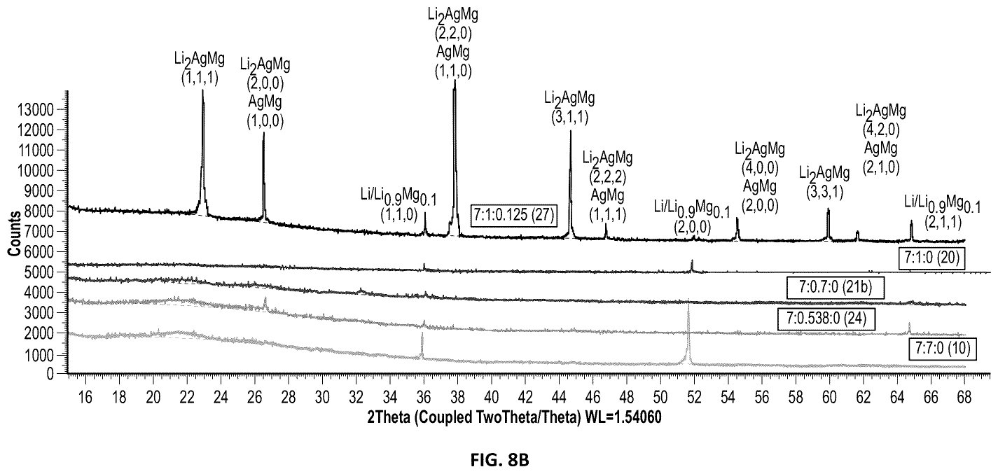

In Example 8A, with reference to FIG. 8A, battery cells fabricated similarly to Example 6A, but with an exploration of a wider variety of controls as the negative electrode to further exemplify the efficacy of the ternary composition Li:Mg:Ag. Here an effort was focused on ensuring the robustness of the conclusion that the ternary Li:Mg:Ag results in much better performance than Li:Mg alloys regardless of the initial stoichiometry of the Li:Mg alloy. In this example it may be seen that a wide variety of Li:Mg alloys (7:0.7:0, 7:1:0, 7:0.538:0) show similar behavior as just pure L metal vs. LiCoO₂. However, a very distinct and drastic improvement in performance is observed when one adds a small amount of Ag to induce the fabrication of the ternary composition (7:1:0.125)

Li Equivalent Cycling Samples vs. LiCoO₂ Positive electrode

### Example 8B

As shown in Example 8B, with reference to FIG. 8B, X-ray diffraction reveals that the addition of even a very small amount of Ag (7:1:0.125) unexpectedly stabilizes a crystal structure associated with Li₂MgAg, although with increased lattice parameter. Here as in all other compositions, the improvement in electrochemical properties are tied to the stabilization of this advantageous crystal structure by a very small amount of Ag that has not been investigated before.

Robustness of the alloy: Increasing the 1Mg:0.125Ag ratio relative to LiCoO₂ Positive electrode

### Example 9A

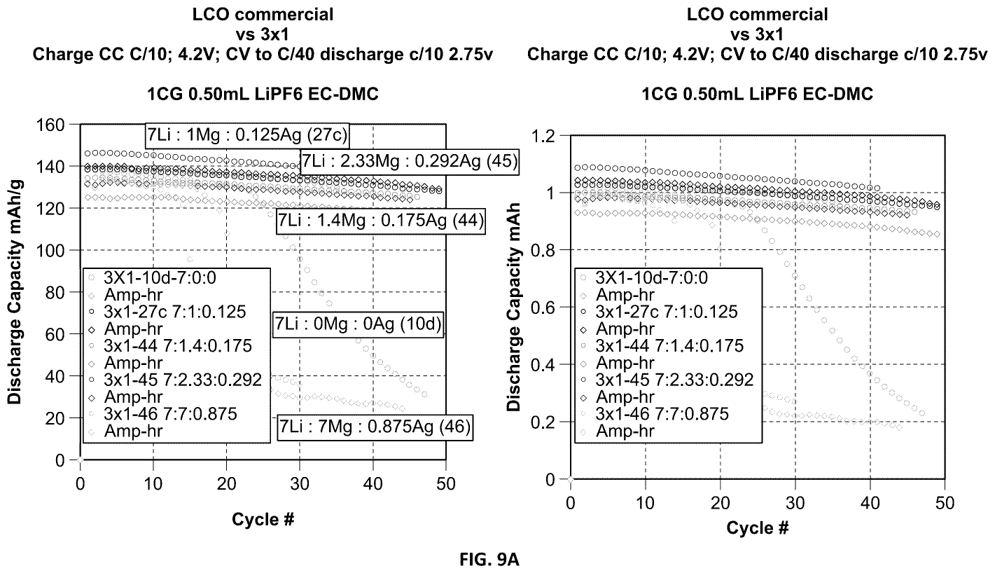

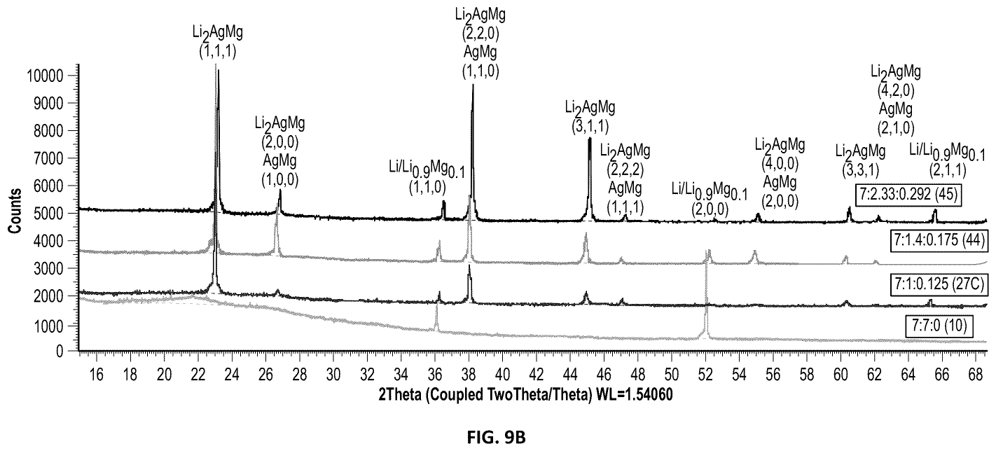

With reference to Example 9A, and FIG. 9A, battery cells were fabricated similarly to Example 6A, but with an exploration of a wider variety of controls as the negative electrode to further exemplify the efficacy of the ternary composition Li:Mg:Ag. Here an effort was focused on ensuring the robustness of the conclusion that the ternary Li:Mg:Ag results in much better performance than Li:Mg alloys regardless of the initial stoichiometry of the Li:Mg:Ag alloy (as opposed to Example 8 which focused on the Li:Mg alloy). In this example it may be seen that a wide variety of Li:Mg:Ag alloys with increasing ratio of (Mg:0.125Ag) to Li content (7:1.4:0.175, 7:2.33:0.292, 7:1:0.125) show similar exceptional behavior vs. the much poorer pure Li metal vs. LiCoO₂. With the best composition at approximately the ternary composition (7:1:0.125). However, if the (Mg: 0.125Ag) ratio becomes too high relative to Li (7:7:0.875), the performance suffers. Robustness of the alloy: Increasing the 1Mg:0.125Ag ratio relative to LiCoO₂ Positive electrode

### Example 9B

As set forth in Example 9B, with reference to FIG. 9B, as may be seen in the XRD diffractograms of the negative electrodes of utilized in Example 6A, there is a clear and systematic improvement of cycle life with the purity of the “Li₂AgMg” like phase present in the diffractograms relative to other phases. Indeed, the purest samples of 7:1:0.125 and 7:2.33:0.292 resulted in the best cycling performance while the other phases became systematically worse with decreasing purity and the presence of deleterious LiMgₓ phase. For all the compositions that resulted in the Li₂AgMg type of structure, the electrochemical performance was excellent.

Reduce Li content relative to the 1:0.125 Mg: Ag ratio vs. LiCoO₂ Positive electrode

### Example 10A

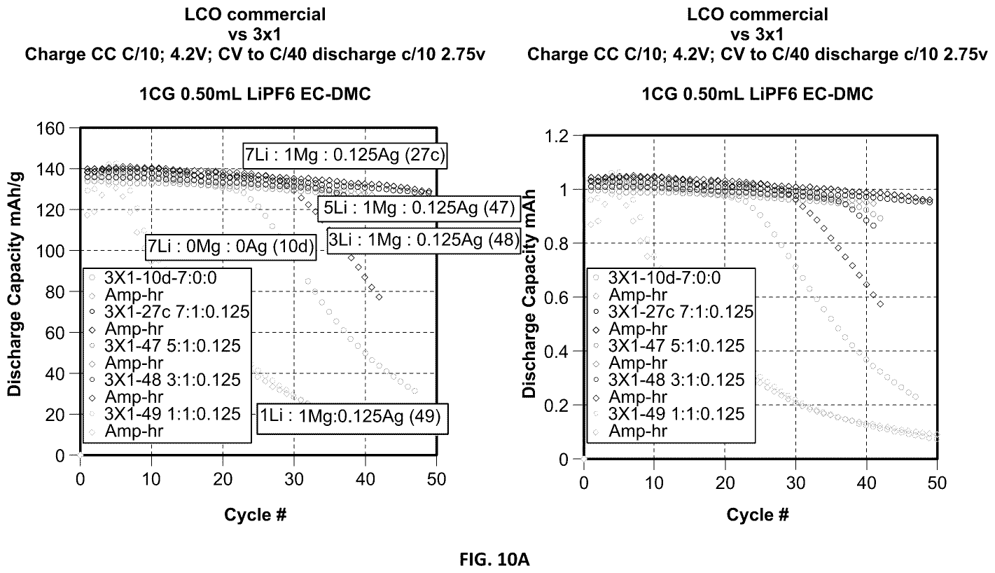

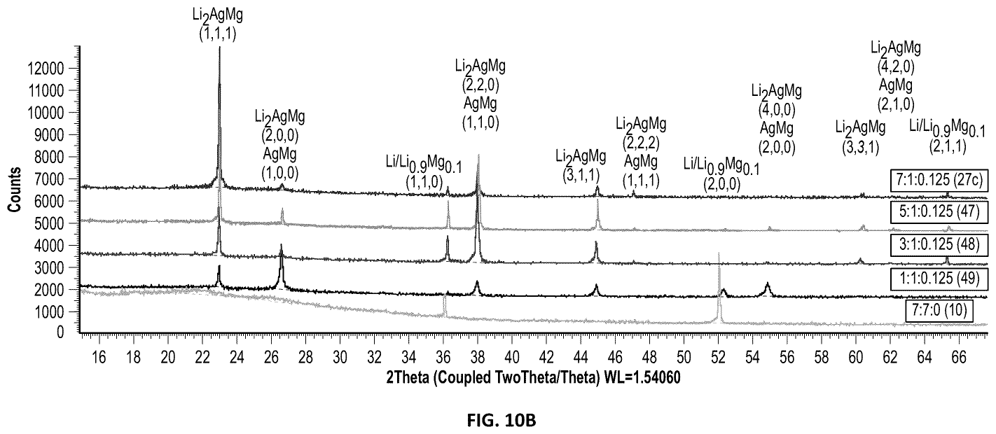

In Example 10A, with reference to FIG. 10A, battery cells were fabricated similarly to Example 6A, but with an exploration of a wider variety of controls as the negative electrode to further exemplify the efficacy of the ternary composition Li:Mg:Ag. Here an effort was focused on ensuring the robustness of the conclusion that the ternary Li:Mg:Ag results in much better performance than Li:Mg alloys regardless of the initial stoichiometry of the Li:Mg:Ag alloy (as opposed to Example 8A which focused on the Li:Mg alloy). In this example it may be seen that a wide variety of Li:Mg:Ag alloys with decreasing Li content (7:1:0.125, 5:1:0.125, 3:1:0.125) show similar exceptional behavior vs. the much poorer pure Li metal vs. LiCoO₂. With the nest composition at approximately the ternary composition (7:1:0.125). However, if Li ratio, again, becomes too low relative to Mg (1:1:0.125), the performance suffers.

Reduce Li content relative to the 1:0.125 Mg: Ag ratio vs. LiCoO₂ Positive electrode

### Example 10B

With reference to Example 10B, and FIG. 10B, as may be seen in the XRD diffractograms of the negative electrodes of utilized in Example 10A, there is a clear and systematic improvement of cycle life with the purity of the “Li₂AgMg” like phase present in the diffractograms relative to other phases. Indeed, the purest sample of 7:1:0.125 resulted in the best cycling performance while 5:1:0.125, 3:1:0.125 became systematically worse with decreasing purity and the presence of deleterious LiMgₓ phase.

Increasing Ag content relative to the 7Li:1Mg ratio vs. LiCoO₂ Positive electrode

### Example 11A

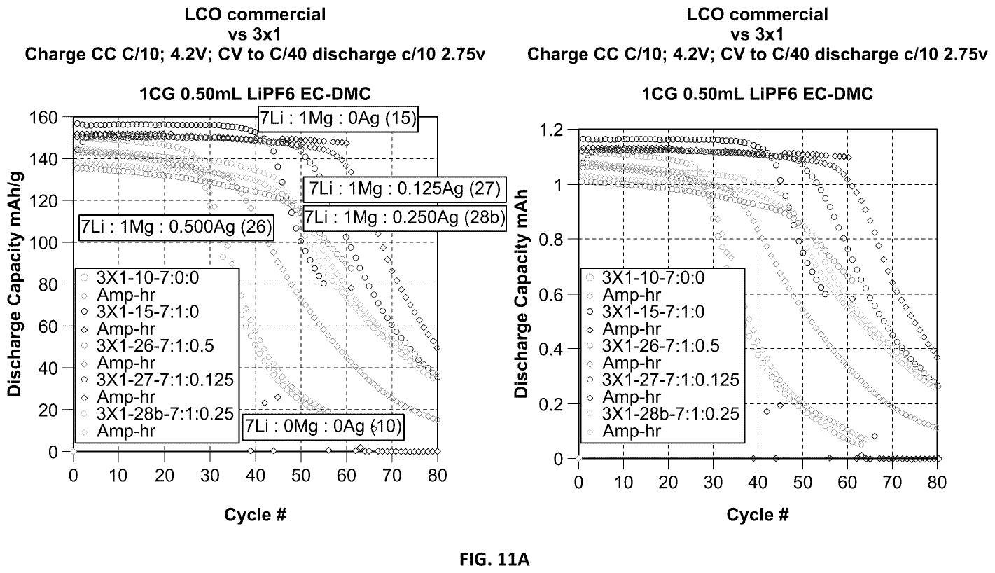

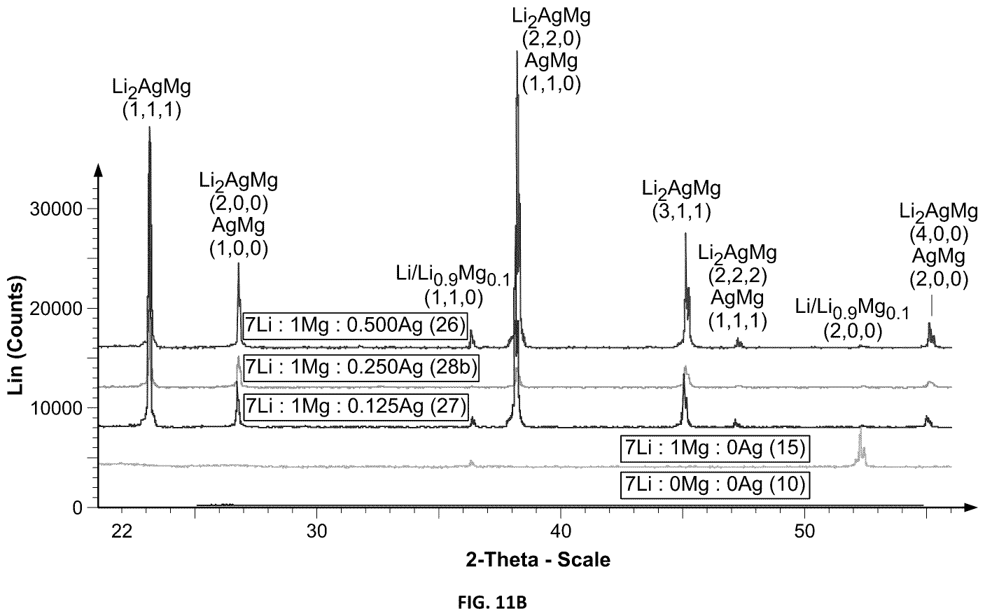

In Example 11A, with reference to FIG. 11A, battery cells were fabricated similarly to Example 6A, but with an exploration of a wider variety of controls as the negative electrode to further exemplify the efficacy of the ternary composition Li:Mg:Ag. In this example, it may be seen that a wide variety of 7Li:1Mg:Agₓ alloys with increasing Ag content (7:1:0, 7:1:0.125, 7:1:0.250) show similar exceptional behavior vs. the much poorer pure Li metal vs. LiCoO₂. With the best composition at approximately the ternary composition (7:1:0.125). However, if the Ag ratio becomes too high relative to Li, the performance suffers somewhat.

Increasing Ag content relative to the 7Li:1Mg ratio vs. LiCoO₂ Positive electrode

### Example 11B

With reference to FIG. 11B, Example 11B is similar to Example 8B, X-ray diffraction reveals that the addition of even a very small amount of Ag in (7:1:0.125) unexpectedly stabilizes a crystal structure associated with Li₂AgMg. Here and in all other ternary compositions investigated compositions, the improvement in electrochemical properties are tied to the stabilization of this advantageous crystal structure by a very small amount of Ag as seen in Example 11A.

Increasing Areal Capacity to 3 mAh/cm² vs. LiCoO₂ Positive Electrodes

### Example 12A

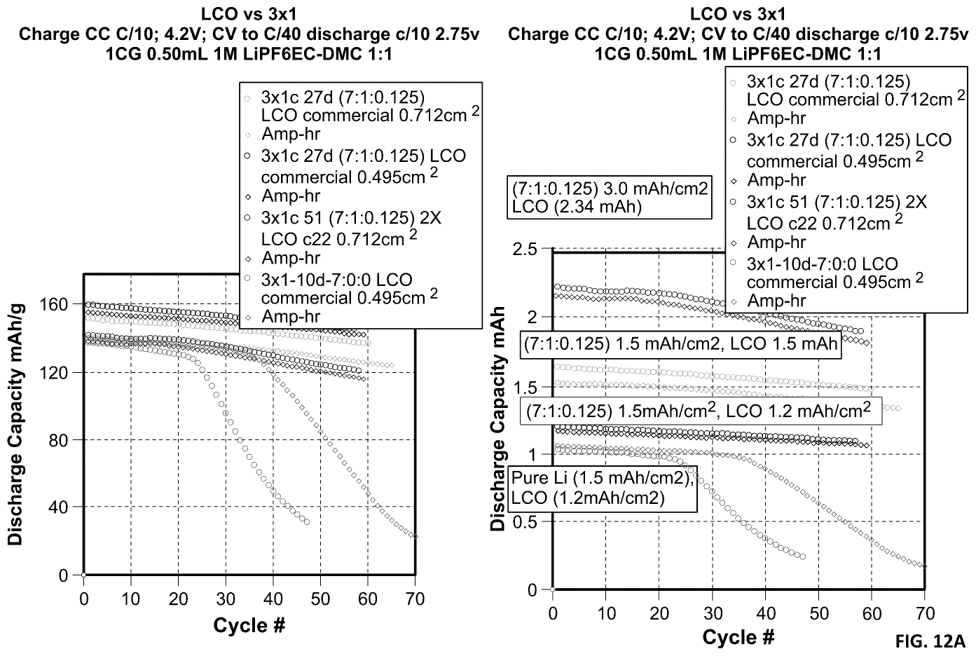

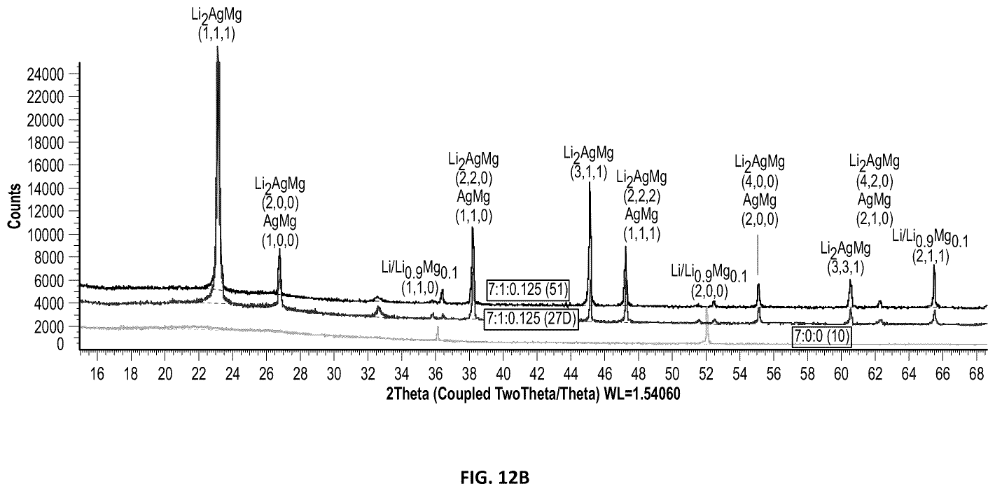

With reference to Example 12A, and FIG. 12A, battery cells were fabricated similarly to Example 6A, but duplicate cells were fabricated with an increasing amount of LiCoO₂ positive electrode utilized in the electrochemical cells ranging from 1.2 mAh/cm² to 3.0 mAh/cm². 3.0 mAh/cm² is a value that is targeted for most commercial applications and demonstrates the ternary alloys unique ability to maintain stable cycling for Li plating. Results show that the alloy is very effective at supporting stable cycling at these areal capacities.

Increasing Areal Capacity to 3 mAh/cm² vs. LiCoO₂ Positive electrodes

### Example 12B

In Example 12B, with reference to FIG. 12B, XRD reveals that all negative electrodes used in Example 12A, except pure Li metal, are of the Li₂AgMg structure.

In some embodiments, the ternary alloy has a crystal structure represented by at least an X-ray diffraction peak corresponding to a d spacing of approximately 3.0 Angstroms. In some embodiments, the d spacing is approximately 3.1 Angstroms. In some embodiments, the d spacing is approximately 3.2 Angstroms. In some embodiments, the d spacing is approximately 3.3 Angstroms. In some embodiments, the d spacing is approximately 3.4 Angstroms. In some embodiments, the d spacing is approximately 3.5 Angstroms. In some embodiments, the d spacing is approximately 3.6 Angstroms. In some embodiments, the d spacing is approximately 3.7 Angstroms. In some embodiments, the d spacing is approximately 3.8 Angstroms. In some embodiments, the d spacing is approximately 3.9 Angstroms. In some embodiments, the d spacing is approximately 4.0 Angstroms. In some embodiments, the d spacing is approximately 4.1 Angstroms. In some embodiments, the d spacing is approximately 4.2 Angstroms. In some embodiments, the d spacing is approximately 4.3 Angstroms. In some embodiments, the d spacing is approximately 4.4 Angstroms. In some embodiments, the d spacing is approximately 4.5 Angstroms. In some embodiments, the d spacing is approximately 4.6 Angstroms. In some embodiments, the d spacing is approximately 4.7 Angstroms. In some embodiments, the d spacing is approximately 4.8 Angstroms. In some embodiments, the d spacing is approximately 4.9 Angstroms. In some embodiments, the d spacing is approximately 5.0 Angstroms.

In some embodiments, the d spacing is approximately 3.0 to 5.0 Angstroms. In some embodiments, the d spacing is approximately 3.1 to 5.0 Angstroms. In some embodiments, the d spacing is approximately 3.2 to 5.0 Angstroms. In some embodiments, the d spacing is approximately 3.3 to 5.0 Angstroms. In some embodiments, the d spacing is approximately 3.4 to 5.0 Angstroms. In some embodiments, the d spacing is approximately 3.5 to 5.0 Angstroms. In some embodiments, the d spacing is approximately 3.6 to 5.0 Angstroms. In some embodiments, the d spacing is approximately 3.7 to 5.0 Angstroms. In some embodiments, the d spacing is approximately 3.8 to 5.0 Angstroms. In some embodiments, the d spacing is approximately 3.9 to 5.0 Angstroms. In some embodiments, the d spacing is approximately 4.0 to 5.0 Angstroms. In some embodiments, the d spacing is approximately 4.1 to 5.0 Angstroms. In some embodiments, the d spacing is approximately 4.2 to 5.0 Angstroms. In some embodiments, the d spacing is approximately 4.3 to 5.0 Angstroms. In some embodiments, the d spacing is approximately 4.4 to 5.0 Angstroms. In some embodiments, the d spacing is approximately 4.5 to 5.0 Angstroms. In some embodiments, the d spacing is approximately 4.6 to 5.0 Angstroms. In some embodiments, the d spacing is approximately 4.7 to 5.0 Angstroms. In some embodiments, the d spacing is approximately 4.8 to 5.0 Angstroms. In some embodiments, the d spacing is approximately 4.9 to 5.0 Angstroms.

In some embodiments, the d spacing is approximately 3.0 to 4.9 Angstroms. In some embodiments, the d spacing is approximately 3.1 to 4.9 Angstroms. In some embodiments, the d spacing is approximately 3.2 to 4.9 Angstroms. In some embodiments, the d spacing is approximately 3.3 to 4.9 Angstroms. In some embodiments, the d spacing is approximately 3.4 to 4.9 Angstroms. In some embodiments, the d spacing is approximately 3.5 to 4.9 Angstroms. In some embodiments, the d spacing is approximately 3.6 to 4.9 Angstroms. In some embodiments, the d spacing is approximately 3.7 to 4.9 Angstroms. In some embodiments, the d spacing is approximately 3.8 to 4.9 Angstroms. In some embodiments, the d spacing is approximately 3.9 to 4.9 Angstroms. In some embodiments, the d spacing is approximately 4.0 to 4.9 Angstroms. In some embodiments, the d spacing is approximately 4.1 to 4.9 Angstroms. In some embodiments, the d spacing is approximately 4.2 to 4.9 Angstroms. In some embodiments, the d spacing is approximately 4.3 to 4.9 Angstroms. In some embodiments, the d spacing is approximately 4.4 to 4.9 Angstroms. In some embodiments, the d spacing is approximately 4.5 to 4.9 Angstroms. In some embodiments, the d spacing is approximately 4.6 to 4.9 Angstroms. In some embodiments, the d spacing is approximately 4.7 to 4.9 Angstroms. In some embodiments, the d spacing is approximately 4.8 to 4.9 Angstroms.

In some embodiments, the d spacing is approximately 3.0 to 4.8 Angstroms. In some embodiments, the d spacing is approximately 3.1 to 4.8 Angstroms. In some embodiments, the d spacing is approximately 3.2 to 4.8 Angstroms. In some embodiments, the d spacing is approximately 3.3 to 4.8 Angstroms. In some embodiments, the d spacing is approximately 3.4 to 4.8 Angstroms. In some embodiments, the d spacing is approximately 3.5 to 4.8 Angstroms. In some embodiments, the d spacing is approximately 3.6 to 4.8 Angstroms. In some embodiments, the d spacing is approximately 3.7 to 4.8 Angstroms. In some embodiments, the d spacing is approximately 3.8 to 4.8 Angstroms. In some embodiments, the d spacing is approximately 3.9 to 4.8 Angstroms. In some embodiments, the d spacing is approximately 4.0 to 4.8 Angstroms. In some embodiments, the d spacing is approximately 4.1 to 4.8 Angstroms. In some embodiments, the d spacing is approximately 4.2 to 4.8 Angstroms. In some embodiments, the d spacing is approximately 4.3 to 4.8 Angstroms. In some embodiments, the d spacing is approximately 4.4 to 4.8 Angstroms. In some embodiments, the d spacing is approximately 4.5 to 4.8 Angstroms. In some embodiments, the d spacing is approximately 4.6 to 4.8 Angstroms. In some embodiments, the d spacing is approximately 4.7 to 4.8 Angstroms.

In some embodiments, the d spacing is approximately 3.0 to 4.7 Angstroms. In some embodiments, the d spacing is approximately 3.1 to 4.7 Angstroms. In some embodiments, the d spacing is approximately 3.2 to 4.7 Angstroms. In some embodiments, the d spacing is approximately 3.3 to 4.7 Angstroms. In some embodiments, the d spacing is approximately 3.4 to 4.7 Angstroms. In some embodiments, the d spacing is approximately 3.5 to 4.7 Angstroms. In some embodiments, the d spacing is approximately 3.6 to 4.7 Angstroms. In some embodiments, the d spacing is approximately 3.7 to 4.7 Angstroms. In some embodiments, the d spacing is approximately 3.8 to 4.7 Angstroms. In some embodiments, the d spacing is approximately 3.9 to 4.7 Angstroms. In some embodiments, the d spacing is approximately 4.0 to 4.7 Angstroms. In some embodiments, the d spacing is approximately 4.1 to 4.7 Angstroms. In some embodiments, the d spacing is approximately 4.2 to 4.7 Angstroms. In some embodiments, the d spacing is approximately 4.3 to 4.7 Angstroms. In some embodiments, the d spacing is approximately 4.4 to 4.7 Angstroms. In some embodiments, the d spacing is approximately 4.5 to 4.7 Angstroms. In some embodiments, the d spacing is approximately 4.6 to 4.7 Angstroms.

In some embodiments, the d spacing is approximately 3.0 to 4.6 Angstroms. In some embodiments, the d spacing is approximately 3.1 to 4.6 Angstroms. In some embodiments, the d spacing is approximately 3.2 to 4.6 Angstroms. In some embodiments, the d spacing is approximately 3.3 to 4.6 Angstroms. In some embodiments, the d spacing is approximately 3.4 to 4.6 Angstroms. In some embodiments, the d spacing is approximately 3.5 to 4.6 Angstroms. In some embodiments, the d spacing is approximately 3.6 to 4.6 Angstroms. In some embodiments, the d spacing is approximately 3.7 to 4.6 Angstroms. In some embodiments, the d spacing is approximately 3.8 to 4.6 Angstroms. In some embodiments, the d spacing is approximately 3.9 to 4.6 Angstroms. In some embodiments, the d spacing is approximately 4.0 to 4.6 Angstroms. In some embodiments, the d spacing is approximately 4.1 to 4.6 Angstroms. In some embodiments, the d spacing is approximately 4.2 to 4.6 Angstroms. In some embodiments, the d spacing is approximately 4.3 to 4.6 Angstroms. In some embodiments, the d spacing is approximately 4.4 to 4.6 Angstroms. In some embodiments, the d spacing is approximately 4.5 to 4.6 Angstroms.

In some embodiments, the d spacing is approximately 3.0 to 4.5 Angstroms. In some embodiments, the d spacing is approximately 3.1 to 4.5 Angstroms. In some embodiments, the d spacing is approximately 3.2 to 4.5 Angstroms. In some embodiments, the d spacing is approximately 3.3 to 4.5 Angstroms. In some embodiments, the d spacing is approximately 3.4 to 4.5 Angstroms. In some embodiments, the d spacing is approximately 3.5 to 4.5 Angstroms. In some embodiments, the d spacing is approximately 3.6 to 4.5 Angstroms. In some embodiments, the d spacing is approximately 3.7 to 4.5 Angstroms. In some embodiments, the d spacing is approximately 3.8 to 4.5 Angstroms. In some embodiments, the d spacing is approximately 3.9 to 4.5 Angstroms. In some embodiments, the d spacing is approximately 4.0 to 4.5 Angstroms. In some embodiments, the d spacing is approximately 4.1 to 4.5 Angstroms. In some embodiments, the d spacing is approximately 4.2 to 4.5 Angstroms. In some embodiments, the d spacing is approximately 4.3 to 4.5 Angstroms. In some embodiments, the d spacing is approximately 4.4 to 4.5 Angstroms.

In some embodiments, the d spacing is approximately 3.0 to 4.4 Angstroms. In some embodiments, the d spacing is approximately 3.1 to 4.4 Angstroms. In some embodiments, the d spacing is approximately 3.2 to 4.4 Angstroms. In some embodiments, the d spacing is approximately 3.3 to 4.4 Angstroms. In some embodiments, the d spacing is approximately 3.4 to 4.4 Angstroms. In some embodiments, the d spacing is approximately 3.5 to 4.4 Angstroms. In some embodiments, the d spacing is approximately 3.6 to 4.4 Angstroms. In some embodiments, the d spacing is approximately 3.7 to 4.4 Angstroms. In some embodiments, the d spacing is approximately 3.8 to 4.4 Angstroms. In some embodiments, the d spacing is approximately 3.9 to 4.4 Angstroms. In some embodiments, the d spacing is approximately 4.0 to 4.4 Angstroms. In some embodiments, the d spacing is approximately 4.1 to 4.4 Angstroms. In some embodiments, the d spacing is approximately 4.2 to 4.4 Angstroms. In some embodiments, the d spacing is approximately 4.3 to 4.4 Angstroms.

In some embodiments, the d spacing is approximately 3.0 to 4.3 Angstroms. In some embodiments, the d spacing is approximately 3.1 to 4.3 Angstroms. In some embodiments, the d spacing is approximately 3.2 to 4.3 Angstroms. In some embodiments, the d spacing is approximately 3.3 to 4.3 Angstroms. In some embodiments, the d spacing is approximately 3.4 to 4.3 Angstroms. In some embodiments, the d spacing is approximately 3.5 to 4.3 Angstroms. In some embodiments, the d spacing is approximately 3.6 to 4.3 Angstroms. In some embodiments, the d spacing is approximately 3.7 to 4.3 Angstroms. In some embodiments, the d spacing is approximately 3.8 to 4.3 Angstroms. In some embodiments, the d spacing is approximately 3.9 to 4.3 Angstroms. In some embodiments, the d spacing is approximately 4.0 to 4.3 Angstroms. In some embodiments, the d spacing is approximately 4.1 to 4.3 Angstroms. In some embodiments, the d spacing is approximately 4.2 to 4.3 Angstroms.

In some embodiments, the d spacing is approximately 3.0 to 4.2 Angstroms. In some embodiments, the d spacing is approximately 3.1 to 4.2 Angstroms. In some embodiments, the d spacing is approximately 3.2 to 4.2 Angstroms. In some embodiments, the d spacing is approximately 3.3 to 4.2 Angstroms. In some embodiments, the d spacing is approximately 3.4 to 4.2 Angstroms. In some embodiments, the d spacing is approximately 3.5 to 4.2 Angstroms. In some embodiments, the d spacing is approximately 3.6 to 4.2 Angstroms. In some embodiments, the d spacing is approximately 3.7 to 4.2 Angstroms. In some embodiments, the d spacing is approximately 3.8 to 4.2 Angstroms. In some embodiments, the d spacing is approximately 3.9 to 4.2 Angstroms. In some embodiments, the d spacing is approximately 4.0 to 4.2 Angstroms. In some embodiments, the d spacing is approximately 4.1 to 4.2 Angstroms.

In some embodiments, the d spacing is approximately 3.0 to 4.1 Angstroms. In some embodiments, the d spacing is approximately 3.1 to 4.1 Angstroms. In some embodiments, the d spacing is approximately 3.2 to 4.1 Angstroms. In some embodiments, the d spacing is approximately 3.3 to 4.1 Angstroms. In some embodiments, the d spacing is approximately 3.4 to 4.1 Angstroms. In some embodiments, the d spacing is approximately 3.5 to 4.1 Angstroms. In some embodiments, the d spacing is approximately 3.6 to 4.1 Angstroms. In some embodiments, the d spacing is approximately 3.7 to 4.1 Angstroms. In some embodiments, the d spacing is approximately 3.8 to 4.1 Angstroms. In some embodiments, the d spacing is approximately 3.9 to 4.1 Angstroms. In some embodiments, the d spacing is approximately 4.0 to 4.1 Angstroms.

In some embodiments, the d spacing is approximately 3.0 to 4.0 Angstroms. In some embodiments, the d spacing is approximately 3.1 to 4.0 Angstroms. In some embodiments, the d spacing is approximately 3.2 to 4.0 Angstroms. In some embodiments, the d spacing is approximately 3.3 to 4.0 Angstroms. In some embodiments, the d spacing is approximately 3.4 to 4.0 Angstroms. In some embodiments, the d spacing is approximately 3.5 to 4.0 Angstroms. In some embodiments, the d spacing is approximately 3.6 to 4.0 Angstroms. In some embodiments, the d spacing is approximately 3.7 to 4.0 Angstroms. In some embodiments, the d spacing is approximately 3.8 to 4.0 Angstroms. In some embodiments, the d spacing is approximately 3.9 to 4.0 Angstroms.

In some embodiments, the d spacing is approximately 3.0 to 3.9 Angstroms. In some embodiments, the d spacing is approximately 3.1 to 3.9 Angstroms. In some embodiments, the d spacing is approximately 3.2 to 3.9 Angstroms. In some embodiments, the d spacing is approximately 3.3 to 3.9 Angstroms. In some embodiments, the d spacing is approximately 3.4 to 3.9 Angstroms. In some embodiments, the d spacing is approximately 3.5 to 3.9 Angstroms. In some embodiments, the d spacing is approximately 3.6 to 3.9 Angstroms. In some embodiments, the d spacing is approximately 3.7 to 3.9 Angstroms. In some embodiments, the d spacing is approximately 3.8 to 3.9 Angstroms.

In some embodiments, the d spacing is approximately 3.0 to 3.8 Angstroms. In some embodiments, the d spacing is approximately 3.1 to 3.8 Angstroms. In some embodiments, the d spacing is approximately 3.2 to 3.8 Angstroms. In some embodiments, the d spacing is approximately 3.3 to 3.8 Angstroms. In some embodiments, the d spacing is approximately 3.4 to 3.8 Angstroms. In some embodiments, the d spacing is approximately 3.5 to 3.8 Angstroms. In some embodiments, the d spacing is approximately 3.6 to 3.8 Angstroms. In some embodiments, the d spacing is approximately 3.7 to 3.8 Angstroms.

In some embodiments, the d spacing is approximately 3.0 to 3.7 Angstroms. In some embodiments, the d spacing is approximately 3.1 to 3.7 Angstroms. In some embodiments, the d spacing is approximately 3.2 to 3.7 Angstroms. In some embodiments, the d spacing is approximately 3.3 to 3.7 Angstroms. In some embodiments, the d spacing is approximately 3.4 to 3.7 Angstroms. In some embodiments, the d spacing is approximately 3.5 to 3.7 Angstroms. In some embodiments, the d spacing is approximately 3.6 to 3.7 Angstroms.

In some embodiments, the d spacing is approximately 3.0 to 3.6 Angstroms. In some embodiments, the d spacing is approximately 3.1 to 3.6 Angstroms. In some embodiments, the d spacing is approximately 3.2 to 3.6 Angstroms. In some embodiments, the d spacing is approximately 3.3 to 3.6 Angstroms. In some embodiments, the d spacing is approximately 3.4 to 3.6 Angstroms. In some embodiments, the d spacing is approximately 3.5 to 3.6 Angstroms.

In some embodiments, the d spacing is approximately 3.0 to 3.5 Angstroms. In some embodiments, the d spacing is approximately 3.1 to 3.5 Angstroms. In some embodiments, the d spacing is approximately 3.2 to 3.5 Angstroms. In some embodiments, the d spacing is approximately 3.3 to 3.5 Angstroms. In some embodiments, the d spacing is approximately 3.4 to 3.5 Angstroms.

In some embodiments, the d spacing is approximately 3.0 to 3.4 Angstroms. In some embodiments, the d spacing is approximately 3.1 to 3.4 Angstroms. In some embodiments, the d spacing is approximately 3.2 to 3.4 Angstroms. In some embodiments, the d spacing is approximately 3.3 to 3.4 Angstroms.

In some embodiments, the d spacing is approximately 3.0 to 3.3 Angstroms. In some embodiments, the d spacing is approximately 3.1 to 3.3 Angstroms. In some embodiments, the d spacing is approximately 3.2 to 3.3 Angstroms.

In some embodiments, the d spacing is approximately 3.0 to 3.2 Angstroms. In some embodiments, the d spacing is approximately 3.1 to 3.2 Angstroms. In some embodiments, the d spacing is approximately 3.0 to 3.1 Angstroms.

Below, we present further embodiment of the invention.

### Experimental:

### Electrode Preparation and Coin Cell Assembly:

Physical vapor deposition (PVD) by way of thermal evaporation was utilized to deposit thin films of Li metal, and combinations of Li, Mg and Ag metals to achieve select stoichiometric ratios. Unless otherwise noted, compositions are nominal compositions as determined before deposition as all constituents were utilized in the deposition process. Lithium content was normalized to 1.4 mAh for all Li containing codeposited depositions. 5-mil copper substrates (1.21 cm²) were used as the deposition substrate, where the deposited thin film area was 0.95 cm². Positive electrode Nb_{0.99}Ta_{0.1}PO₅ (NTPO) was utilized as the non-Li containing insertion positive electrode and prepared using 70 wt. % NTPO, 10 wt. % carbon and 20 wt. % PVdF-HFP polymer binder. Lithium cobalt (III) oxide (LiCoO₂, LCO), utilized as the Li containing insertion positive electrode, was prepared using 80 wt % LCO, 8 wt. % carbon and 12 wt. % PVdF-HFP polymer binder (15.06 mg/cm², 0.495 cm²). Both positive electrode disks were dried overnight at 120° C. under vacuum. Coin cells were prepared under argon with less than 0.1 ppm water and oxygen content. Single layer Celgard separator (25 μm) was used in coin cell construction and whetted using 50 μl of standard electrolyte 1M LiPF₆ EC/DMC.

### Electrochemical Characterization:

Electrochemical testing was conducted using a Bio-logic Galvano/potentiostat. Coin cells constructed with PVD thin film negative electrodes and LCO positive electrodes were charged at constant current C/10 to 4.2V, followed by constant voltage to current cutoff of C/40, followed by a constant current discharge C/10 to 2.75V. Alternatively, coin cells constructed instead with positive electrode NTPO were discharged 15 mA/g to 1.65V and charged 10 mA/g to 2.8V. Charge and discharge capacity with cycling are evaluated for both experiments.

### Physical Characterization:

### X-Ray Diffraction:

Negative electrode Li:Mg:Ag thin film depositions on glass slides were characterized via X-ray diffraction (ex-situ XRD) with a Bruker D8 diffractometer (Cu ka, wavelength=1.54056 Å) utilizing a scan rate of 0.6185 degrees/min. The negative electrode Li:Mg:Ag thin film deposition was sealed using Kapton® to limit environmental contamination and oxidation. Generated XRD patterns were utilized to understand phase differences between deposited compositions and processed using EVA and TOPAZ Rietveld refinement programs. In-situ XRD analysis was performed utilizing an in-house developed cell, where the negative electrode Li:Mg:Ag thin film deposition is on a porous Cu mesh substrate (Li_{0.0072}/scan, 2.45 degrees/min).

### X-Ray Photoelectron Spectroscopy:

Phase distribution and chemical characterization with depth were evaluated using X-ray photoelectron spectroscopy (XPS, K-Alpha, Thermo Scientific). An electron flood gun was utilized to account for potential surface charging effects. Argon sputtering (2 keV) was utilized to reveal the subsurface film regions. (will add specific sputtering protocol).

### Results:

Optimization of Li:Mg:Ag negative electrodes vs. NTPO

Li-ion Configuration: Baseline Li benchmarks vs. NTPO

The use of non-Li containing insertion compounds as positive electrodes in a Li-ion battery configuration allows for the direct evaluation of Li removal from the negative electrode with limited influence of deleterious reactions via Li plating including, interaction of Li metal with electrolyte and, most importantly, masking of inefficiencies related to an abundance of Li reserve in a half cell configuration vs Li metal. Here, a NTPO positive electrode, previously developed to allow for negligible first cycle losses and excellent cycling stability, is used in excess capacity vs that of the thin film negative electrode to ensure full dilithiation of the alloy to evaluate and develop optimized alloy compositions for Li-metal stabilization (as detailed in the Experimental section) 9. Additionally, this configuration may be relevant to enable future high energy density battery configurations which feature high energy density, non-lithiated, positive electrodes such as Sulfur or Metal Fluoride composites.

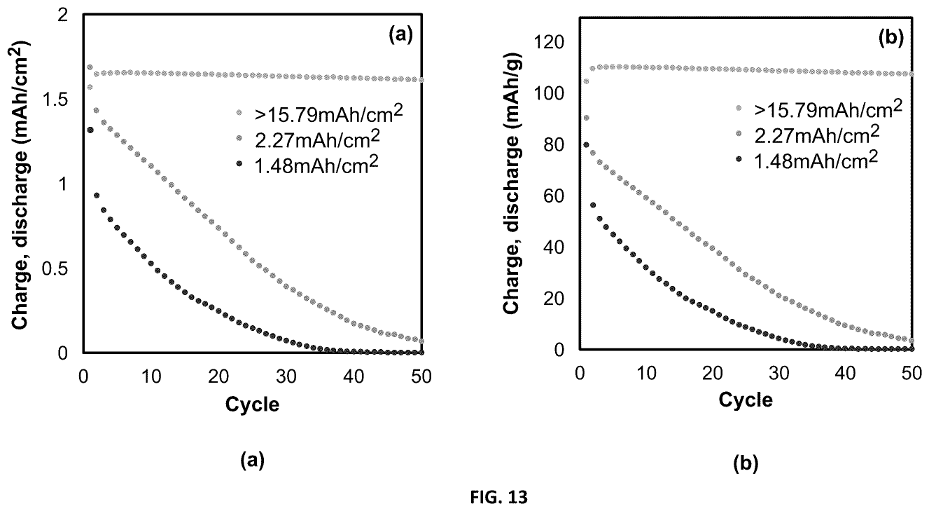

As shown in FIG. 13, baseline deposited Li metal films which contain identical amounts of Li metal (1.48 mAh/cm²) as most of the lithium containing alloy films studied of this paper and a Li metal disk (150 μm Li metal, >15.79 mAh/cm²) were evaluated vs a NTPO positive electrode. As expected, the cycling stability of the high capacity Li metal disk outperformed that of the lower capacity 2.27 mAh/cm² and 1.48 mAh/cm² Li thin films, due to the excess reserve of Li metal and ability to withstand Li consumption resulting from electrolyte interaction. However, despite improved performance, a large excess of Li-metal cannot be practically incorporated to enable high energy density cells from both energy density and safety considerations. Thus, to take advantage of the high energy density capabilities of Li-metal, improvements upon these electrodes must be made to enhance stability.

FIG. 13 shows discharge and charge areal capacity (mAh/cm²) for Li metal films vs NTPO (a) and specific capacity (mAh/g NTPO) (b) observed to cycle 50 for Li metal thin film benchmarks vs NTPO cells. Li metal thin film benchmarks utilized include >15.79 mAh/cm² (red), 2.27 mAh/cm² (green) and 1.48 mAh/cm² (blue) negative electrodes of the given calculated areal capacities.

a. Improvements of the Li Thin Film Using Mg and Ag Alloys

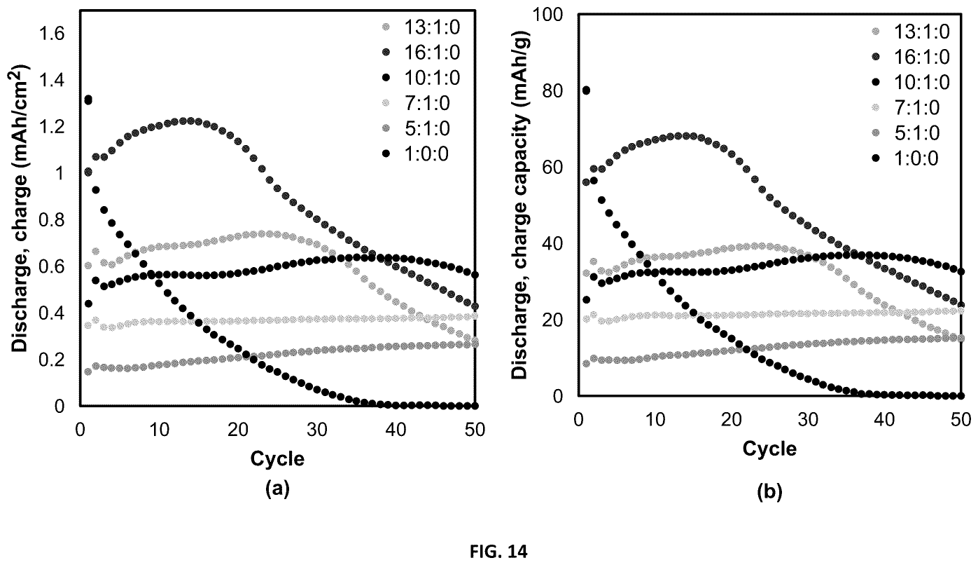

Mg was incorporated into the Li thin film deposition composition in an effort to evaluate influence on performance. As shown in FIG. 14, codeposited Li:Mg alloys were investigated in the normalized stoichiometric ratios of 1:0, 16:1, 13:1, 10:1, 7:1 and 5:1 vs. positive electrode NTPO where discharge capacity is observed to cycle 50. Here, the normalized Li metal benchmark film exhibited high initial capacity but failed rapidly compared to all other Li:Mg compositions shown. The introduction of a small amount of Mg (16Li:1Mg) improved upon this initial performance while still maintaining high initial capacity, however, capacity fade was still observed after approximately 25 cycles. Alternatively, increasing the Mg content by reducing this ratio further to 10:1, 7:1 and 5:1 reduces initial capacity but significantly improved cycling stability for all of the aforementioned compositions, where an ideal combination of Li-metal stabilization and reduced capacity was observed for a ratio of 7:1-10:1. This observed reduced capacity below that of the available theoretical capacity is likely due to transport limitations.

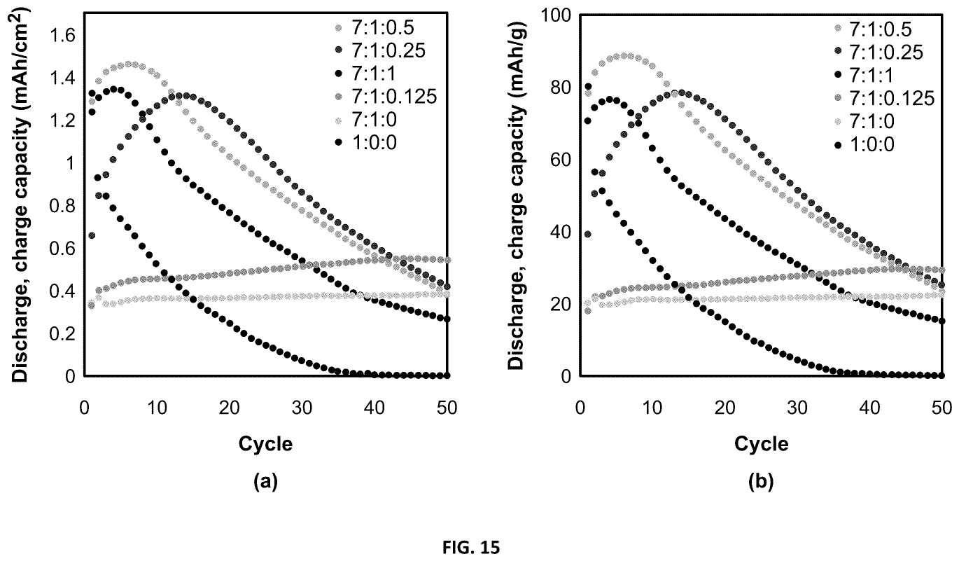

To address this challenge and increase the achievable capacity, Ag metal was introduced into the alloy due to its high electronic conductivity, large atomic size, and its ability to alloy with Li metal at low voltages and possibility of extended solid solutions. Utilizing the beneficial 7:1 Li:Mg ratio identified previously, Ag was added to this composition in increasing stoichiometric ratios (7:1:0.125, 7:1:0.25, 7:1:0.5 and 7:1:1 of Li:Mg:Ag). As shown in FIG. 15, the addition of a small amount of Ag in the ratio of 7:1:0.125 resulted in excellent cyclability and capacity retention, as well as almost a 50% increase in capacity relative to the same composition lacking Ag (7:1:0). Further increase in the relative silver content to 7:1:0.25, 7:1:0.5 and 7:1:1 significantly improved capacity (by almost 400% for 7:1:0.5), however, at the cost of faster capacity fade. In summary, a substantial improvement in cycling stability was observed with the addition of small amounts of Mg to a pure Li composition (7:1) at the cost of areal capacity, however, that resultant reduction in capacity can be very significantly improved through the addition of a small amount of Ag to the alloy composition (7:1:0.125).

FIG. 14 shows discharge and charge areal capacity (mAh/cm²) for Li:Mg films cycled vs NTPO (a) and specific capacity (mAh/g NTBO) (B) observed to cycle 50 for Li:Mg:Ag thin films vs NTPO cells. Li:Mg:Ag thin film negative electrode compositions shown here include ratios of 16:1:0 (blue), 13:1:0 (red), 10:1:0 (black), 7:1:0 (yellow), 5:1:0 (green) as well as a normalized Li metal film benchmark (light blue), where all Li containing compositions contain the same amount of Li.

FIG. 15 shows discharge and charge areal capacity (mAh/cm²) for ternary Li:Mg:Ag films vs NTPO (A) and specific capacity (mAh/g NTPO) (B) observed to cycle 50 for Li:Mg:Ag thin films vs NTPO Li-ion cells. Li:Mg:Ag thin film negative electrode compositions shown here include ratios of 7:1:0.125 (green), 7:1:0.25 (blue), 7:1:0.5 (red), and 7:1:1 (black) as well as a normalized Li metal film (light blue) and a 7:1Li:Mg benchmark (yellow), where all Li containing compositions contain the same amount of Li.

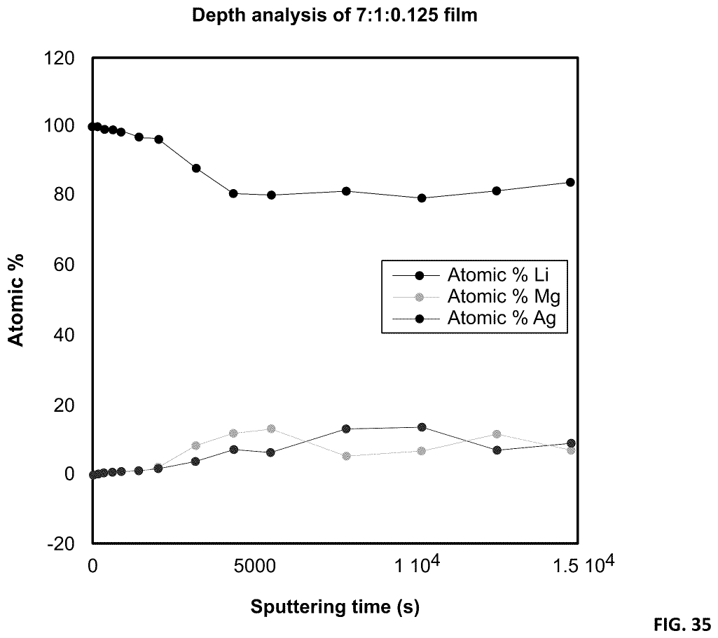

Given the substantial improvement in performance of the Ag incorporating compositions, X-ray diffraction was utilized to understand and identify potential enabling phases within these compositions. As shown in FIG. 35, the XRD patterns of the Li:Mg:Ag compositions feature the formation of strong Bragg reflections related to the Li₂AgMg and also AgMg intermetallic phases, where compositions lacking the Ag component, 7:0:0 and 7:1:0, feature only pure Li or Li_{0.9}Mg_{0.1} phases, respectively. Thus, improved performance observed for 7:1:0.125 and 7:1 compositions may be due to the formation of Li₂AgMg and AgMg phases, where the Li₂AgMg phase is enabled by a very small amount of Ag. Additional details regarding phase and composition of films will be discussed in later sections.

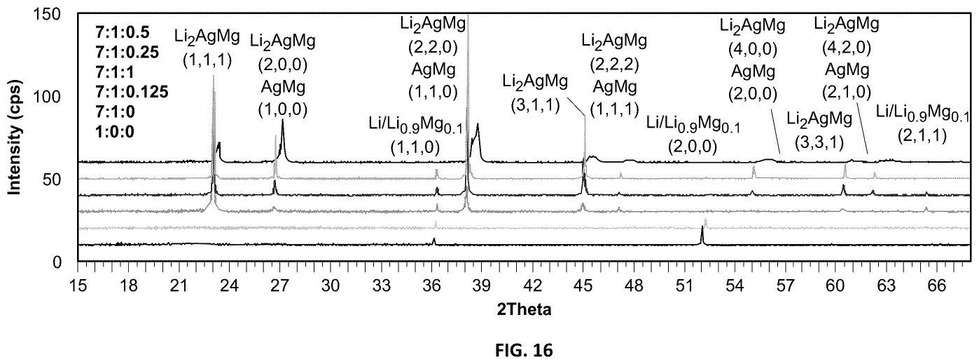

FIG. 16 shows XRD patterns for Li:Mg:Ag thin film negative electrode compositions including ratios of 7:1:0.125, 7:1:0.25, 7:1:0.5, and 7:1:1 as well as a normalized Li metal film and a 7:1 Li:Mg benchmark.

b. Evaluation of Li:Mg:Ag Compositions Using Excess Li

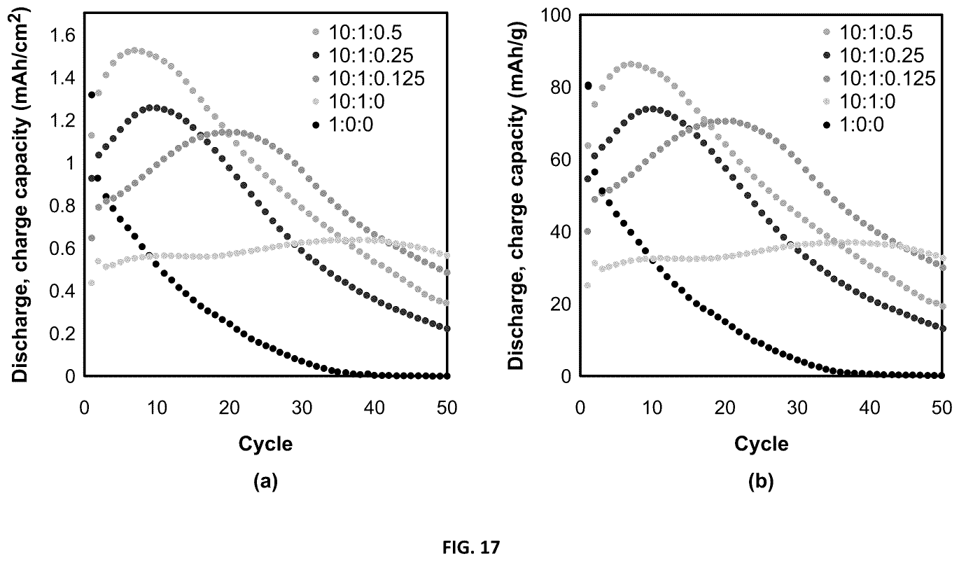

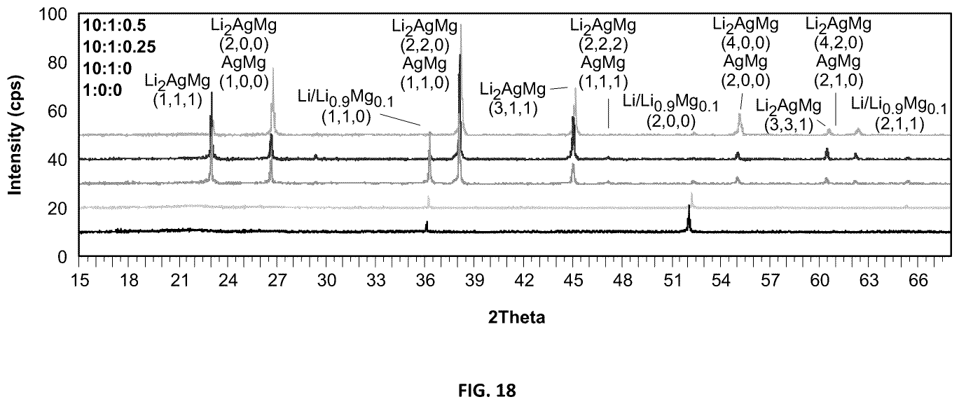

As shown in the previous section, Li:Mg compositions of 10:1 and 13:1 show improved performance relative to the pure Li benchmark containing the same normalized Li content (Table 1). Here, similar ratios of Ag additions utilized in the 7:1 Li: Mg optimization are used to further evaluate these compositions. As shown in FIG. 17, the introduction of Mg to the Li film (10:1) results in significant improvement in cyclability over the pure Li film at the expense of reduced capacity (a trend also observed for the 7:1 Li:Mg film). Here, the addition of a small amount of Ag (10:1:0.125) results in a significant 30-40% increase in capacity and moderate capacity retention. Further increasing the Ag content to 10:1:0.25 and 10:1:0.5 result in significant increases in capacity (>100% increase for 10:1:0.5) however also with an increase in capacity fade as observed previously. Given this improvement in performance, XRD was utilized again to identify potential enabling phases. As shown in in FIG. 18, the addition of a small amount of Ag to the 10:1 Li:Mg composition (10:1:0.125) results in the formation of the significant content of the Li₂AgMg phase observed within the high performance 7:1:0.125 composition from the previous section.

FIG. 17 shows discharge and charge capacity (mAh/cm²) for ternary Li:Mg:Ag films vs NTPO (A) and specific discharge capacity (mAh/g NTBO) (B) observed to cycle 50 for Li:Mg:Ag thin films vs NTPO cells. Li:Mg:Ag thin film negative electrode compositions shown here include ratios of 10:1:0.125 (green), 10:1:0.25 (blue), and 10:1:0.5 (red) as well as a normalized Li metal film (black) and a 10:1:0 (yellow) Li:Mg benchmark, where all Li containing compositions contain the same amount of Li.

FIG. 18 shows XRD patterns for Li:Mg:Ag thin film negative electrode compositions including ratios of 10:1:0.5 (red), 10:1:0.25 (blue), 10:1:0.125 (green), 10:1:0 (yellow) as well as a normalized Li metal film and a 10:1 Li:Mg benchmark (black).

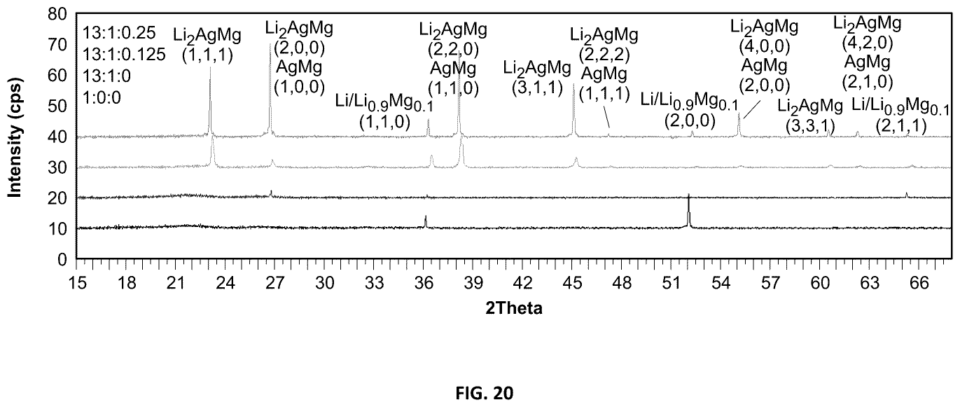

Similarly, optimization of the beneficial 13:1 Li:Mg composition (identified above) using additions of Ag (13:1:0.25) revealed a very significant improvement in capacity relative to the pure Li and 13:1 Li:Mg compositions. However, similar to observations of the previously discussed 10:1 Li:Mg compositions, an increase in capacity with the addition of Ag is also accompanied by an increase in capacity fade. Additionally, as shown in FIG. 20, the addition of Ag to the 13:1 composition (13:1:0.125, 13:1:0.25) results in the formation of the same Li₂AgMg and AgMg intermetallic phases observed previously.

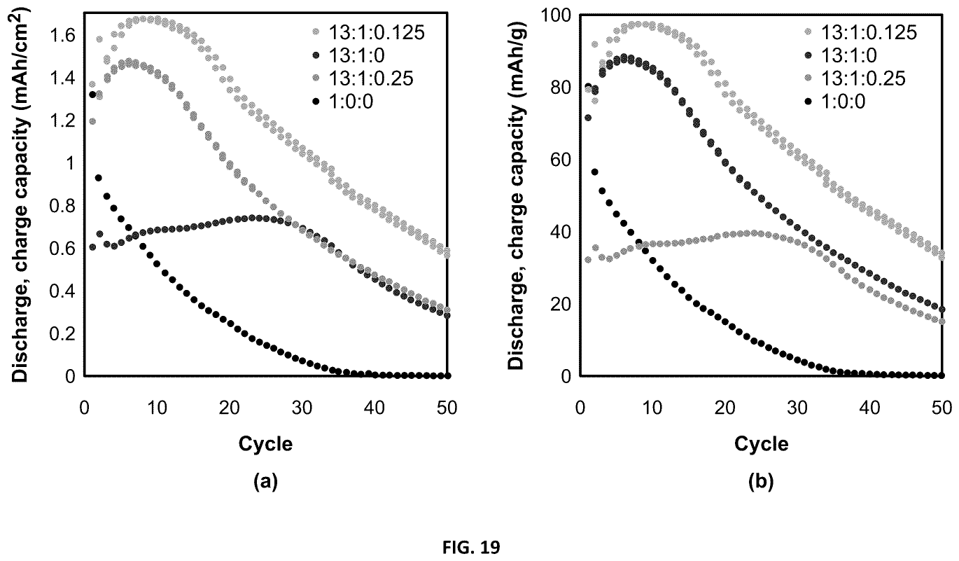

FIG. 19 shows discharge and charge areal capacity (mAh/cm²) for ternary Li:Mg:Ag films vs NTPO (A) and specific capacity (mAh/g NTBO) (B) observed to cycle 50 for Li:Mg:Ag thin films vs NTPO cells. Li:Mg:Ag thin film negative electrode compositions shown here include ratios of 13:1:0.125 (red), 13:1:0.25 (green) as well as a normalized Li metal film (black) and a 13:1:0 Li:Mg benchmark (blue), where all Li containing compositions contain the same amount of Li.

FIG. 20 shows XRD patterns thin film negative electrode compositions including Li:Mg:Ag ratios of 13:1:0.25 (green), 13:1:0.125 (red), 13:1:0 (blue) as well as a normalized Li metal film benchmark (black).

In summary, through the evaluation of thin film depositions of Li:Mg:Ag, the addition of Mg to a pure Li composition in the ratio of 7:1:0, 10:1:0, and 13:1:0 all outperformed Li metal alone in terms of cycling stability, however suffered from significantly decreased capacity (Table 2). The addition of very small amount of Ag to these compositions significantly improved the capacity of these alloys while retaining excellent cycling stability in Li-ion configuration vs NTPO. However, higher relative Li content compositions, especially the 13:1:0.125 and 13:1:0.25 compositions suffered from an earlier onset of capacity fade. Based on initial XRD analysis, the stabilization was induced by the transformation to a Li₂AgMg and AgMg intermetallic alloy phases which have not been studied for use in Li batteries yet. As shown in Table 3, initial results have revealed a potential solid solution formation induced by the formation of the Li₂AgMg phase, where increasing the relative lithium content of the Li:Mg:Ag thin film from 7 to 13 Li within the 1:0.125 Ag:Mg and 1:0.25 Ag:Mg systems results in a gradual decrease in the Li₂AgMg phase lattice parameter and increase in the AgMg lattice parameter. However, despite the potential solid solution formation found within these ternary compositions, greater relative ratios of Li:Mg and Mg: Ag may be detrimental. Thus, from this initial optimization vs NTPO, a Li:Mg:Ag ratio of 7:1:0.125 was initially isolated to provide the greatest benefit out of all the compositions observed here as evidenced by excellent cycling stabilities and a moderate recovery of capacity compared to the Li thin film alone as well as the 7:1 Li:Mg composition. In the following section, the capabilities of the 7:1:0.125 composition are further explored vs LCO.

TABLE 1
Li:Mg:Ag composition ratios along with ratios normalized for
Li content utilized in electrochemical evaluation and XRD analysis.
Table 1. Li:Mg:Ag compositions with normalized Li content

| Li:Mg:Ag alloy | Li Normalized |
|---|---|
| composition | Li:Mg:Ag |
| (composition #) | Composition |
| 1:0:0 (#10) | 1:0:0 |
| 7:1:0 (#20) | 1:0.143:0 |
| 10:1:0 (#21) | 1:0.1:0 |
| 5:1:0 (#22) | 1:0.2:0 |
| 13:1:0 (#24) | 1:0.077:0 |
| 16:1:0 (#25) | 1:0.063:0 |
| 7:1:1 (#23) | 1:0.143:0.143 |
| 7:1:0.5 (#26) | 1:0.143:0.071 |
| 7:1:0.125 (#27) | 1:0.143:0.018 |
| 7:1:0.25 (#28) | 1:0.143:0.036 |
| 10:1:0.125 (#30) | 1:0.1:0.0125 |
| 10:1:0.25 (#31) | 1:0.1:0.025 |
| 10:1:0.5 (#32) | 1:0.1:0.05 |
| 13:1:0.125 (#29) | 1:0.077:0.010 |
| 13:1:0.25 (#33) | 1:0.077:0.019 |

Additional compositions evaluated vs LCO

| | |
|---|---|
| 5:1:0.125 (#47) | 1:0.2:0.025 |
| 3:1:0.125 (48) | 1:0.333:0.042 |
| 1:1:0.125 | 1:1:0.125 |
| 7:2.233:0.292 (45) | 1:0.319:0.042 |
| 7:1.4:0.175 (44) | 1:0.2:0.025 |
| 7:7:0 (35) | 1:1:0 |
| 7:2.33:0 (34) | 1:0.333:0 |
| 7:0.7:0 (21b) | 1:0.1:0 |
| 7:0.538:0 (24) | 1:0.077:0 |
| 7:1:0.125 | 2:0.286:0.036 |
| (doubled)(51) | |

TABLE 2
Maximum lithium extracted in areal capacity (mAh/cm2) of thin film
Li:Mg:Ag compositions vs NTPO during cycling. The cycle at which the
maximum lithium extraction was observed is shown in the right column.
Table 2. Maximum Li extraction (mAh/cm²) of Li:Mg:Ag compositions

| Li:Mg:Ag | | Max capacity vs | |
|---|---|---|---|
| alloy | Li Normalized | NTPO (discharge, | |
| composition | Composition | mAh/cm²) | Cycle |
| 1:0:0 (#10) | 1:0:0 | 1.320 | 1 |
| 16:1:0 (#25) | 1:0.062:0 | 1.225 | 14 |
| 13:1:0 (#24) | 1:0.076:0 | 0.739 | 23 |
| 10:1:0 (#21) | 1:0.1:0 | 0.639 | 36 |
| 7:1:0 (#20) | 1:0.142:0 | 0.385 | 50 |
| 5:1:0 (#22) | 1:0.2:0 | 0.264 | 50 |
| 7:1:0.125 (#27) | 1:0.142:0.017 | 0.547 | 45 |
| 7:1:0.25 (#28) | 1:0.142:0.035 | 1.541 | 14 |
| 7:1:0.5 (#26) | 1:0.142:0.071 | 1.457 | 6 |
| 7:1:1 (#23) | 1:0.142:0.142 | 1.342 | 4 |
| 10:1:0.125 (#30) | 1:0.1:0.0125 | 1.139 | 20 |
| 10:1:0.25 (#31) | 1:0.1:0.025 | 1.255 | 10 |
| 10:1:0.5 (#32) | 1:0.1:0.05 | 1.524 | 7 |
| 13:1:0.125 (#29) | 1:0.0769:0.009 | 1.673 | 8 |
| 13:1:0.25 (#33) | 1:0.0769:0.0192 | 1.386 | 6 |

TABLE 3
Lattice parameters and compositional percentage of
Li2AgMg and AgMg phases present in Li:Mg:Ag thin film
compositions including 7:1:0.125, 7:1:0.25, 7:1:0.5, 7:1:1,
10:1:0.125, 10:1:0.25, 10:1:0.5, 13:1:0.125 and 13:1:0.25.
Table 3. Lattice parameters and phase percentage
of Li:Mg:Ag compositions

| | Li₂AgMg | | AgMg | |
|---|---|---|---|---|
| | Lattice | | Lattice | |
| Compositions | parameter | | parameter | |
| LiMg:Ag | (Å) | Phase % | (Å) | Phase % |
| 7:1:0.125 (27c) | 6.671 | 65.02 | 3.336 | 2.24 |
| 7:1:0.25 (28) | 6.667 | 71.26 | 3.334 | 7.98 |
| 7:1:0.5 (26) | 6.656 | 75.73 | 3.328 | 9.22 |
| 7:1:1 (23) | 6.588 | 51.15 | 3.462 | 0.03 |
| 10:1:0.125 (30) | 6.665 | 62.86 | 3.332 | 5.20 |
| 10:1:0.25 (31) | 6.664 | 80.21 | 3.332 | 2.44 |
| 10:1:0.5 (32) | 6.657 | 96.84 | 2.961 | 0.61 |
| 13:1:0.125 (29) | 6.657 | 81.02 | 3.329 | 3.51 |
| 13:1:0.25 (33) | 6.657 | 54.31 | 3.329 | 7.45 |

### 1. Evaluation of Li:Mg:Ag Negative Electrodes Vs LCO

A. Influence of Li Ratio within the 1:0.125 Mg: Ag System

Given the success of the 7:1 Li:Mg structure in stabilizing the pure Li metal anode as well as the addition of Ag to significantly improve capacity along with cycling stability in the previous section, especially within the 7:1:0.125 composition, similar analysis is now applied using a Li-containing insertion compound. Here, instead of removing the Li content of the thin film negative alloy electrode for insertion into the NTPO cathode, we have removed Li from the Li containing insertion compound LCO for reaction or plating onto the negative thin film electrode. In this way, we have achieved a more realistic understanding of the functionality of this beneficial thin film composition within a more commercially relevant cell configuration utilizing observations of initial irreversible capacity losses and capacity fade with cycling. Within this commercially relevant cell configuration, we have introduced additional Li:Mg:Ag compositions to further understand and isolate the benefits enabled by the 7:1:0.125 composition identified within the previous section but within a phase window of (7₊ₓ:1:0.125) vs (7₋ₓ:1:0.125) as investigated previously, where all compositions utilized contained fixed Li content (Table 1).

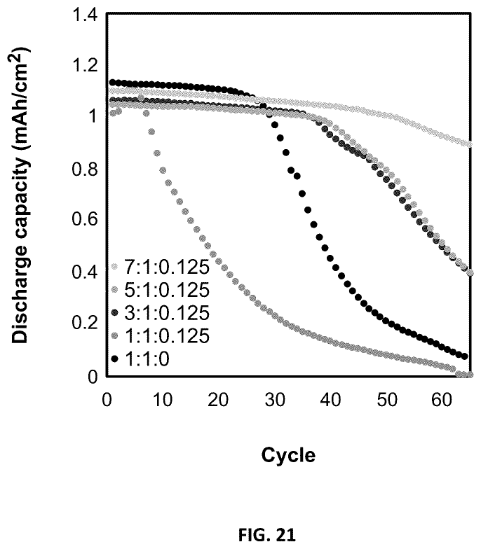

As observed in the previous section, the ratio of Li within the 1:0.125 Mg; Ag system significantly influences cyclability and achievable capacity vs NTPO. Further exploration of the role of Li within the 1:0.125 Mg: Ag system, where additional ratios of 5:1:0.125, 3:1:0.125, and 1:1:0.125 are included, reveal diminished electrochemical performance as the Li:Mg and Li:Ag ratios approach 1:1 (FIG. 21). As shown, slightly higher irreversible capacity loss in addition to a significantly earlier onset of detrimental capacity fade is observed as the relative Li content is reduced to 5:1:0.125 (2.81% loss), 3:1:0.125 (2.73% loss), and 1:1:0.125 (13.79% loss) as compared to the beneficial 7:1:0.125 composition (2.28% loss) (FIG. 21, Table 4), where all compositions contain a fixed normalized Li content (Table 1). Thus, a detrimental ratio of Li:Mg and Li:Ag exists where performance is diminished, where at the extreme end (1:1:0.125) performance is significantly diminished even relative to the poorly performing Li metal benchmark (1:0:0). As such, an ideal Li:Mg and Li:Ag ratio exists that enables high discharge capacity retention and low irreversible losses, through the formation of a beneficial groundwork for Li plating and morphological evolution with cycling.

XRD characterization of the above film compositions suggest that a unique amount of binary: ternary phase ratios within the film may contribute to greater capacity retention (and not necessarily only high ternary purity). As shown in Table 5, poorly performing composition 1:1:0.125 incorporates the lowest amount of ternary phase within this set, and the lowest ternary: binary phase ratio. Compositions 5:1:0.125 and 3:1:0.125 show improved electrochemical performance, likely due to the relative increase in ternary phase as compared to the 1:1:0.125 composition (79.50, 69.87 vs 43.57%). Electrochemical differences between these already improved compositions may be due to the relative percentage of binary phase, where the slightly better performing 3:1:0.125 composition features a relatively higher ternary: binary ratio that is similar to that of the best performing 7:1:0.125 composition (now where electrochemical differences may relate to Li₂AgMg lattice expansion). Thus, unique range of ternary: binary phase percentage may be needed to accommodate greater capacity retention and cyclability vs LCO as these components may allow for more favorable accommodation of excess Li⁺ via LCO.

FIG. 21 shows discharge capacity (mAh/cm²) for ternary Li:Mg:Ag films vs LCO observed as a function of cycle number to cycle 65. Li:Mg:Ag thin film negative electrode compositions shown here include ratios of 7:1:0.125 (yellow), 5:1:0.125 (red), 3:1:0.125 (blue), 1:1:0.125 (green) as well as a normalized Li metal benchmark 1:0:0 (black), where all Li containing compositions contain the same amount of Li.

TABLE 4
First cycle % irreversible loss for Li:Mg:Ag
compositions including 7:1:0.125, 5:1:0.125,
3:1:0.125, 1:1:0.125 and Li metal benchmark 1:0:0.
Table 4. First cycle percentage irreversible
loss for Li:Mg:Ag compositions

| | % irreversible |
|---|---|
| Composition | loss |
| 7:1:0.125 | 2.28 |
| 5:1:0.125 | 2.81 |
| 3:1:0.125 | 2.73 |
| 1:1:0.125 | 13.79 |
| 1:0:0 | 3.35 |

TABLE 5
Lattice parameters and compositional percentage of
Li₂AgMg and AgMg phases present in Li:Mg:Ag thin
film compositions including 7:1:0.125, 5:1:0.125,
3:1:0.125, 1:1:0.125 and Li metal benchmark 1:0:0.
Table 5. Lattice parameters and phase
percentage of Li:Mg:Ag compositions

| | Li₂AgMg | | AgMg | |
|---|---|---|---|---|
| | Lattice | | Lattice | |
| Compositions | parameter | | parameter | |
| Li:Mg:Ag | (Å) | Phase % | (Å) | Phase % |
| 7:1:0.125 (27c) | 6.671 | 65.02 | 3.336 | 2.24 |
| 5:1:0.125 (47) | 6.666 | 79.50 | 3.362 | 0.48 |
| 3:1:0.125 (48) | 6.684 | 69.87 | 3.343 | 2.84 |
| 1:1:0.125 (49) | 6.689 | 43.57 | 3.342 | 0.27 |

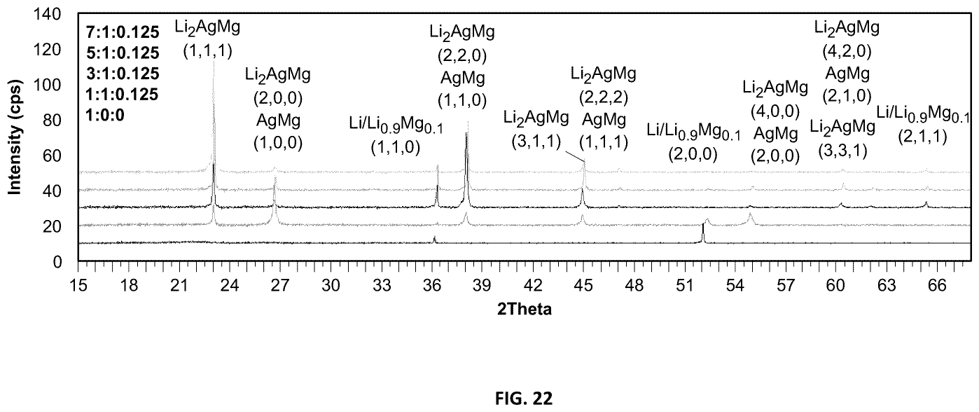

FIG. 22 shows XRD patterns of Li:Mg:Ag compositions including 7:1:0.125 (yellow), 5:1:0.125 (red), 3:1:0.125 (blue), 1:1:0.125 (green) and Li metal benchmark 1:0:0 (black).

B. Influence of the Ag Ratio within the 7:1 Li:Mg System

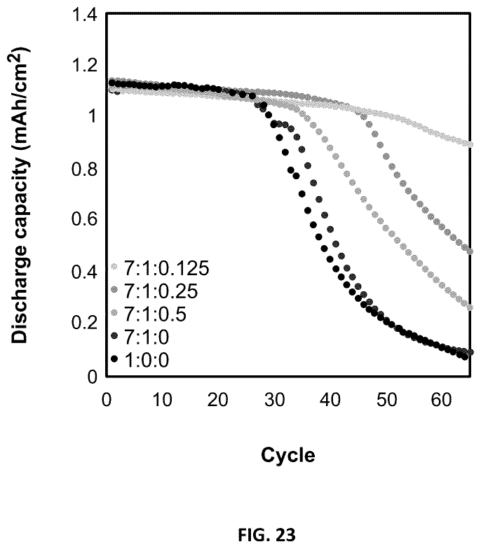

As observed in the previous section, the ratio of Ag within the 7:1 Li:Mg system significantly influences cyclability and achievable capacity vs NTPO. Here, modifications of the Ag ratio within the 7:1 Li:Mg system were investigated. As shown in FIG. 23, the addition of a small amount of Ag to the 7:1 Li:Mg composition (achieving 7:1:0.125) results in significant improvement in capacity retention with cycling as well as a reduction in first cycle loss, a trend also observed in the previous sections vs NTPO. However, increasing the relative Ag content above 0.125 results in significant decrease in performance as well as an increase in corresponding irreversible capacity loss (FIG. 23, Table 5). Thus, similar to trends observed in the previous section, approaching Li:Ag and Ag:Mg ratios near 1:1 prove to be detrimental relative to composition 7:1:0.125. As shown in Table 5, the above trend can be further supported through analysis of corresponding Li₂AgMg and AgMg lattice parameters, where increasing the respective Ag:Mg ratio results in an increase in AgMg lattice but a decrease in Li₂AgMg lattice. Additionally, corresponding ternary phase percentages decrease as this Ag:Mg ratio nears 1, a trend opposite to that observed for the AgMg phase.

FIG. 23 shows discharge capacity (mAh/cm²) for ternary Li:Mg:Ag films vs LCO observed as a function of cycle number to cycle 65 Li:Mg:Ag thin film negative electrode compositions shown here include ratios of 7:1:0.125 (yellow), 7:1:0.25 (green), 7:1:0.5 (red), 7:1:0 (blue) as well as a normalized Li metal benchmark 1:0:0 (black), where all Li containing compositions contain the same amount of Li.

TABLE 6
First cycle % irreversible loss for Li:Mg:Ag
compositions including 7:1:0.5, 7:1:0.25,
7:1:0.125 and Li metal benchmark 1:0:0.
Table 6. First cycle percentage irreversible
loss for Li:Mg:Ag compositions

| | % irreversible |
|---|---|
| Composition | loss |
| 7:1:0.5 (26) | 2.91 |
| 7:1:0.25 (28) | 3.66 |
| 7:1:0.125 (27c) | 2.28 |
| 7:1:0 (20) | 4.28 |
| 1:0:0 (10) | 3.35 |

TABLE 7
Lattice parameters and compositional
percentage of Li₂AgMg and AgMg phases
present in Li:Mg:Ag thin film compositions
including 7:1:0.5, 7:1:0.25, and 7:1:0.125.
Table 7. Lattice parameters and phase
percentage of Li:Mg:Ag compositions

| | Li₂AgMg | | AgMg | |
|---|---|---|---|---|
| | Lattice | | Lattice | |
| Compositions | parameter | | parameter | |
| Li:Mg:Ag | (Å) | Phase % | (Å) | Phase % |
| 7:1:0.5 (26) | 6.656 | 75.73 | 3.328 | 9.22 |
| 7:1:0.25 (28) | 6.667 | 71.26 | 3.334 | 7.98 |
| 7:1:0.125 (27c) | 6.671 | 65.02 | 3.336 | 2.24 |

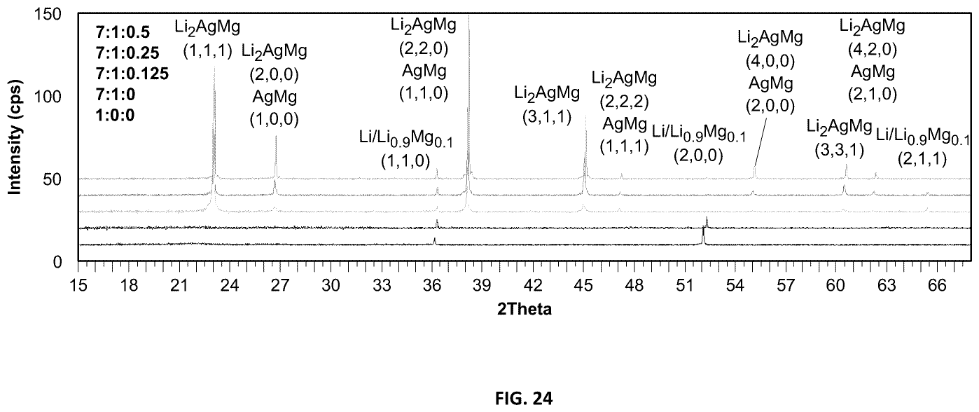

FIG. 24 shows XRD patterns of Li:Mg:Ag compositions including 7:1:0.5 (red), 7:1:0.25 (green), 7:1:0.125 (yellow), 7:1:0 (blue) and Li metal benchmark 1:0:0 (black).

### C. Influence of the Percentage Mg: Ag Ratio Relative to Li

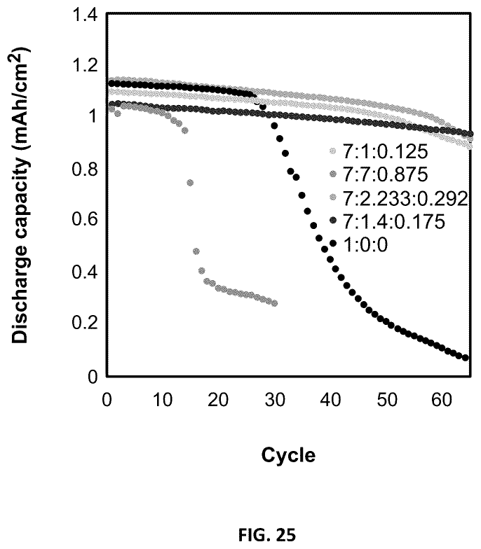

Given the significant influence observed between the relative ratios of Li:Mg Li:Ag, and Mg:Ag explored above, the relative percentage of a fixed 1Mg:0.125Ag was varied within the normalized Li composition. Increasing this relative Mg:Ag content to 1.40:0.175 and 2.233:0.292, a 40% and 120%, respectively, resulted in slightly greater first cycle irreversible capacity loss, however cycling performance was observed to be similar to that of the 7:1:0.125 composition, suggesting a tandem functional role between Ag:Mg components in establishing a favorable environment for Li incorporation, potentially in the form of an alloy continuum or eventual Li metal plating. (FIG. 25, Table 7).

FIG. 25 shows discharge capacity (mAh/cm²) for ternary Li:Mg:Ag films vs LCO observed as a function of cycle number to cycle 65. Li:Mg:Ag thin film negative electrode compositions shown here include ratios of 7:2.233:0.292 (red), 7:1.4:0.175 (blue), 7:1:0.125 (yellow) as well as a normalized Li metal benchmark 1:0:0 (black), where all Li containing compositions contain the same amount of Li.

TABLE 8
First cycle % irreversible loss for Li:Mg:Ag
compositions including 7:2.233:0.292, 7:1.40:0.175,
7:1:0.125 and Li metal benchmark 1:0:0.
Table 8. First cycle percentage irreversible
loss for Li:Mg:Ag compositions

| | % irreversible |
|---|---|
| Composition | loss |
| 7:2.233:0.292 (45) | 2.45 |
| 7:1.4:0.175 (44) | 3.03 |
| 7:1:0.125 (27c) | 2.28 |
| 1:0:0 (10) | 3.35 |

TABLE 9
Lattice parameters and compositional percent-
age of Li₂AgMg and AgMg phases present in
Li:Mg:Ag thin film compositions including
7:2.233:0.292, 7:1.40:0.175, 7:1:0.125.
Table 9. Lattice parameters and phase
percentage of Li:Mg:Ag compositions

| | Li₂AgMg | | AgMg | |
|---|---|---|---|---|
| | Lattice | | Lattice | |
| Compositions | parameter | | parameter | |
| Li:Mg:Ag | (Å) | Phase % | (Å) | Phase % |
| 7:2.233:0.292 (45) | 6.664 | 91.41 | 3.359 | 0.1 |
| 7:1.40:0.175 (44) | 6.675 | 46.2 | 3.337 | 10.71 |
| 7:1:0.125 (27c) | 6.671 | 65.02 | 3.336 | 2.24 |

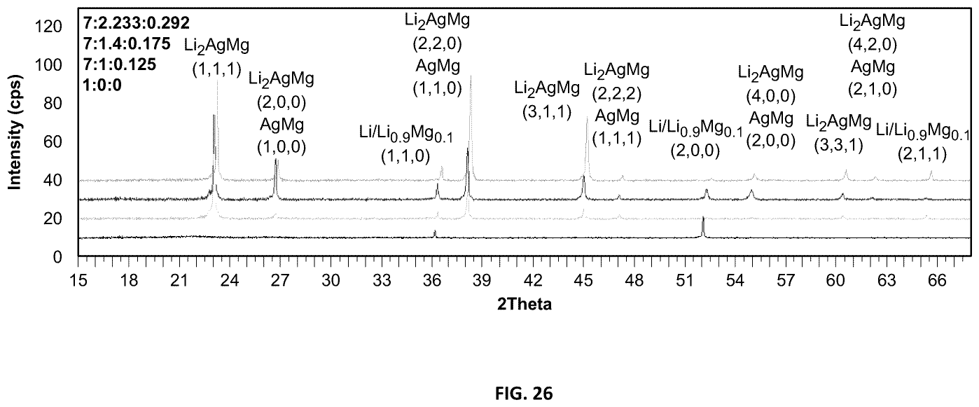

FIG. 26 shows XRD patterns of Li:Mg:Ag compositions including 7:2.233:0.292 (red), 7:1.40:0.175 (blue), 7:1:0.125 (yellow) and Li metal benchmark 1:0:0 (black).

### D. Further Evaluation of Binary Li:Mg and Mg:Ag Compositions

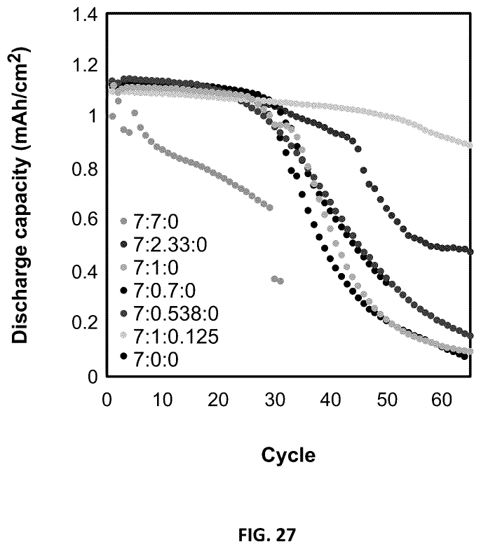

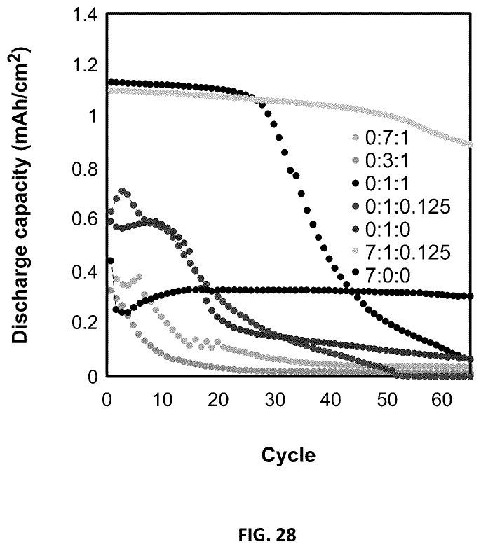

Given the success of the 7:1-2.33:0.125-0.292 thin film composition in establishing low irreversible loss and good cycling stability, binary compositions of Li:Mg and Mg:Ag were further explored to understand the robustness of this compositional range. As shown, binary combinations of Li:Mg including 7:7, 7:2.33, 7:1, and 7:07 fall short in meeting the performance of the 7:1:0.125 composition, where compositions approaching 1:1 Li:Mg exhibit the worst performance (FIG. 27, Table 10). Additionally, binary combinations of Mg: Ag were evaluated, and compositions incorporating relatively lower Ag concentrations relative to the Mg concentration (0:7:1, 0:3:1, 0:1:0.125) exhibited poor performance relative to Li metal alone, the beneficial 7:1:0.125 composition, as well as the binary Li:Mg compositions evaluated above (FIG. 28, Table 11). The addition of Li to the 0:1:0. 125 binary composition (achieving 7:1:0.125) results in an increase in the AgMg binary phase and reduction in the AgMg lattice parameter to 3.336 Å (vs 3.278 Å) (Table 12).

Further increasing the Ag content of the Mg: Ag binary composition, achieving a ratio of 0:1:1, shows improvement in overall capacity retention to cycle 65 similar to that of the beneficial 7:1:0.125 composition, although with diminished initial capacity as well as a decrease in the AgMg lattice parameter. This leaves the question open to whether the AgMg binary phase transforms into the ternary Li₂AgMg

In summary, the removal of Li from the 7:1:0.125 composition reveals similar cycling performance to Mg alone (0:1:1), where no significant benefit to performance is observed when the relative Mg: Ag ratio is increased. The lattice parameter of this binary 0:1:0.125 composition does not approximate that 7:1:0.125. Instead, the 7:1:0.125 composition AgMg phase lattice approaches the lattice parameter of the 0:7:1 phase (3.336 Å vs 3.306 Å respectively). Thus, in addition to a certain range AgMg phase percentage, as discussed above, a given range of lattice parameters (≥3.336 Å) may be indicative of favorable ternary and binary phase interaction that can sustain high performance. Given the reduction in performance as Ag is added up to a 0:1:1 composition, relative to Mg alone (0:1:0) as well as the improved performance of 7:1:0.125 relative to its binary counterpart (0:1:0.125) suggest that only a certain range of AgMg phase presence is beneficial to sustain capacity retention.

FIG. 27 shows discharge capacity (mAh/cm²) for ternary Li:Mg:Ag films vs LCO observed as a function of cycle number to cycle 65. Li:Mg:Ag thin film negative electrode compositions shown here include ratios of 7:7:0 (green), 7:2.33:0 (blue), 7:1:0 (red), 7:0.7:0 (light blue), 7:0.538:0 (pink), 7:1:0.125 (yellow) as well as a normalized Li metal benchmark 7:0:0 (black), where all Li containing compositions contain the same amount of Li.

TABLE 10
First cycle % irreversible loss for Li:Mg:Ag compositions
including 7:7:0, 7:2.33:0, 7:1:0, 7:0.7:0, 7:1:0.125 as
well as a normalized Li metal benchmark 7:0:0.
Table 10. First cycle percentage irreversible loss
for Li:Mg:Ag compositions

| | % irreversible |
|---|---|
| Composition | loss |
| 7:7:0 (35) | 14.08 |
| 7:2.33:0 (34) | 4.95 |
| 7:1:0 (20) | 4.28 |
| 7:0.7:0 (21b) | 5.68 |
| 7:0.538:0 (24) | 10.10 |
| 7:1:0.125 (27c) | 2.28 |
| 1:0:0 (10) | 3.35 |

FIG. 28 shows discharge capacity (mAh/cm²) for ternary Li:Mg:Ag films vs LCO observed as a function of cycle number to cycle 65. Li:Mg:Ag thin film negative electrode compositions shown here include ratios of 0:7:1 (red), 0:3:1 (green), 0:1:1 (light blue), 0:1:0.125 (pink), 0:1:0 (blue), 7:1:0.125 (yellow) as well as a normalized Li metal benchmark 7:0:0 (black), where all Li containing compositions contain the same amount of Li.

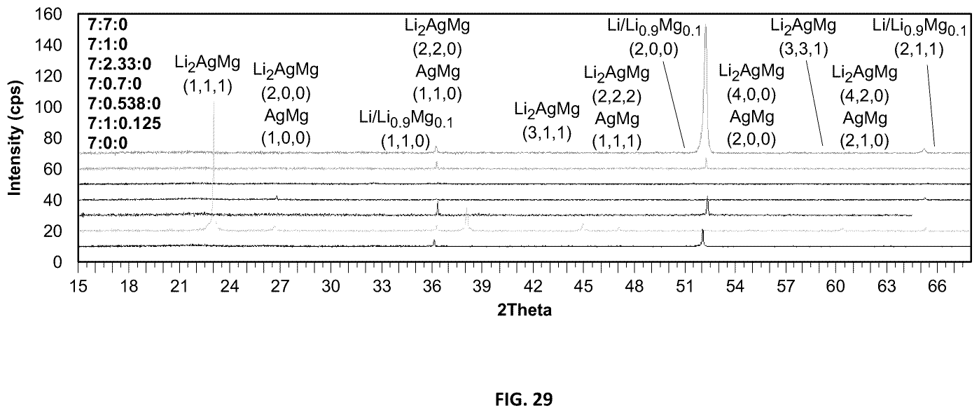

FIG. 29 shows XRD patterns of Li:Mg:Ag compositions including 7:7:0 (green), 7:1:0 (red), 7:0.7:0 (light blue), 7:0.538:0 (pink), 7:2.33:0 (dark blue), 7:1:0.125 (yellow) as well as a normalized Li metal benchmark 7:0:0 (black).

TABLE 11
First cycle % irreversible loss for Li:Mg:Ag compositions
including 0:7:1, 0:3:1, 0:1:1, 0:1:0.125, 0:1:0, 7:1:0.125
as well as a normalized Li metal benchmark 7:0:0.
Table 11. First cycle percentage irreversible loss
for Li:Mg:Ag compositions

| | % irreversible |
|---|---|
| Composition | loss |
| 0:7:1 (40) | 62.14 |
| 0:3:1 (41) | 70.66 |
| 0:1:1 (R12-A) | 63.00 |
| 0:1:0.125 (R02) | 78.78 |
| 0:1:0 (38) | 50.45 |
| 7:1:0.125 (27c) | 2.28 |
| 1:0:0 (10) | 3.35 |

TABLE 12
Lattice parameters and compositional percentage of Li₂AgMg
and AgMg phases present in Li:Mg:Ag thin film compositions
including 0:7:1, 0:3:1, 0:1:1, 0:1:0.125 and 7:1:0.125.
Table 12. Lattice parameters and phase percentage of
Li:Mg:Ag compositions

AgMg

| | Lattice | |
|---|---|---|
| Compositions | parameter | |
| Li:Mg:Ag | (Å) | Phase % |
| 0:7:1 | 3.306 | 44.71 |
| 0:3:1 | 3.286 | 2.56 |
| 0:1:1 (12A) | 3.287 | 28.17 |
| 0:1:0.125 (R02) | 3.278 | 0.05 |
| 7:1:0.125 (27c) | 3.336 | 2.24 |

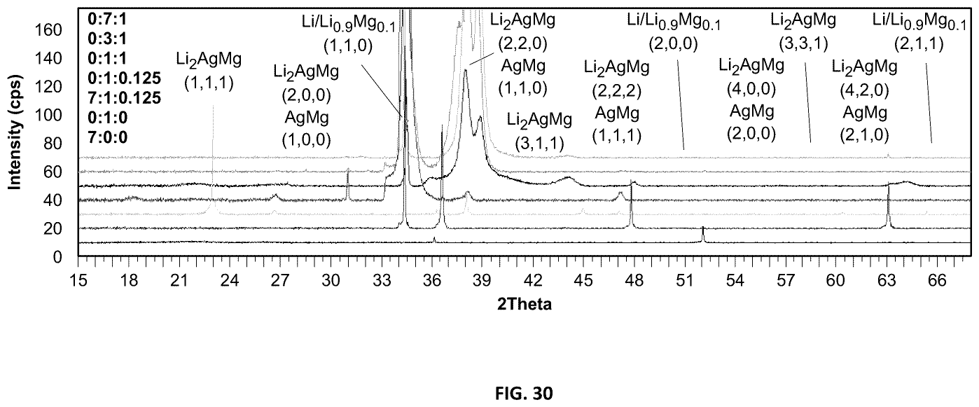

FIG. 30 shows XRD patterns of Li:Mg:Ag compositions including 0:7:1 (red), 0:3:1 (green), 0:1:1 (light blue), 0:1:0.125 (pink), 7:1:0.125 (yellow), 0:1:0 (dark blue) and normalized Li metal benchmark 7:0:0 (black).

### E. High Areal Capacity 7:1:0.125 Composition Films

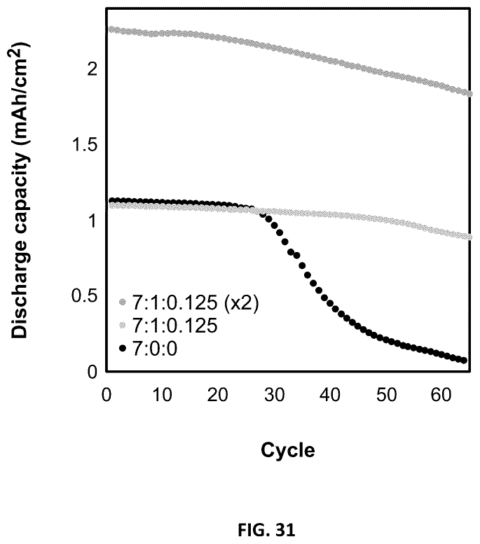

Given the success of the 7:1:0.125 composition normalized to near 1.4 mAh/cm², a higher areal capacity deposition was evaluated in order to probe the practical stability of this ternary composition and the potentially beneficial Li₂AgMg phase in the commercially utilized 2-3 mAh/cm² areal capacity range. Here, the 7:1:0.125 composition has been doubled (>2 mAh/cm²), and still realized stable performance vs LCO (FIG. 31, Table 11). Additionally, this higher capacity composition may allow for additional solid solution formation, as evidenced by a slight decrease in the Li₂AgMg lattice parameter as compared to that of the 1.1 mAh/cm² 7:1:0.125 composition. Both the single and doubled 7:1:0.125 composition exhibit similar ratios of ternary: binary phase percentages, where the single 7:1:0.125 composition exhibits a greater phase percentage of Li metal.

FIG. 31 shows discharge capacity (mAh/cm²) for ternary Li:Mg:Ag films vs LCO observed as a function of cycle number to cycle 65. Li:Mg:Ag thin film negative electrode compositions shown here include ratios of 7:1:0.125. doubled thickness 7:1:0.125 as well as a normalized Li metal benchmark 7:0:0, where all Li containing compositions contain the same amount of Li.

TABLE 13
First cycle % irreversible loss for Li:Mg:Ag compositions
including 7:1:0.125, doubled deposition 7:1:0.15 as well
as a normalized Li metal benchmark 7:0:0.
Table 13. First cycle percentage irreversible loss
for Li:Mg:Ag compositions

| | % irreversible |
|---|---|
| Composition | loss |
| 7:1:0.125 (2x)(51) | 2.09 |
| 7:1:0.125 (27c) | 2.28 |
| 1:0:0 (10) | 3.35 |

TABLE 14
Lattice parameters and compositional percentage of Li₂AgMg
and AgMg phases present in Li:Mg:Ag thin film compositions
including 7:1:0.125 and doubled 7:1:0.125.
Table 14. Lattice parameters and phase percentage
of Li:Mg:Ag compositions

| | Li₂AgMg | | AgMg | |
|---|---|---|---|---|
| | Lattice | | Lattice | |
| Compositions | parameter | | parameter | |
| Li:Mg:Ag | (Å) | Phase % | (Å) | Phase % |
| 7:1:0.125 (51) | 6.666 | 92.65 | 3.747 | 4.04 |
| 7:1:0.125 (27c) | 6.671 | 65.02 | 3.336 | 2.24 |

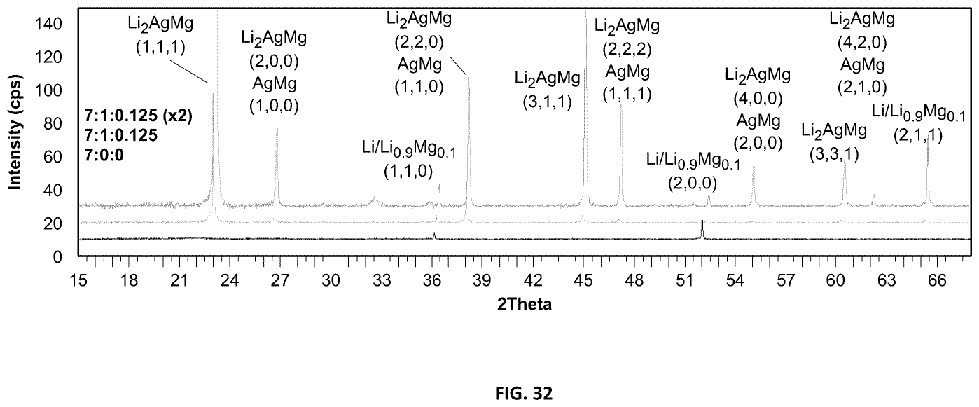

FIG. 32 shows XRD patterns of Li:Mg:Ag compositions including doubled thickness composition 7:1:0.125 (>2 mAh/cm²) (red) and 7:1:0.125 (1.1 mAh/cm²) (yellow), and normalized Li metal benchmark 7:0:0 (1.1 mAh/cm²) (black).

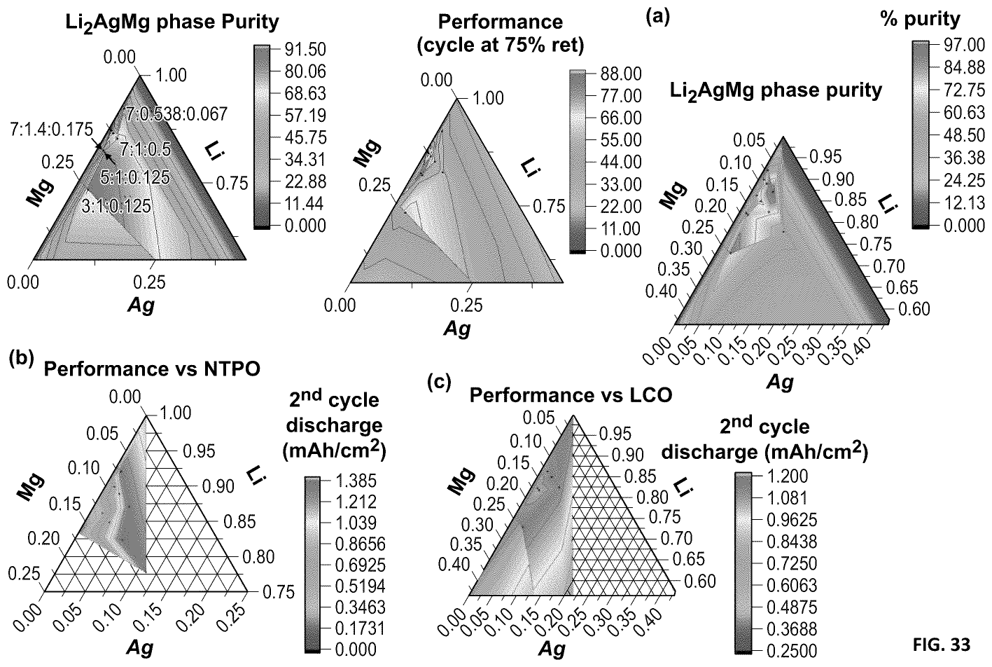

FIG. 33 shows schematic depicting Li₂AgMg phase purity of all ternary compositions (a) and corresponding performance vs NTPO (b) and LCO (c). Performance evaluated based on second discharge capacity (mAh/cm²).

### 2. Depth Evaluation of High Performance 7:1:0.125 Composition

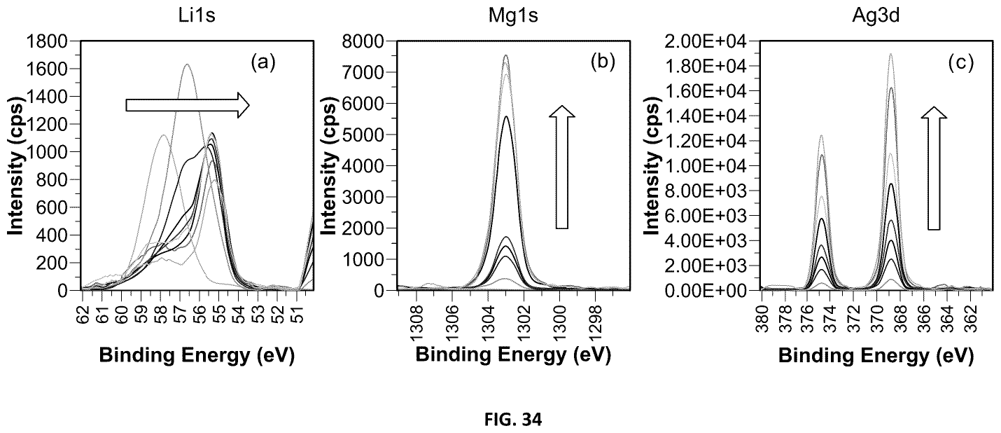

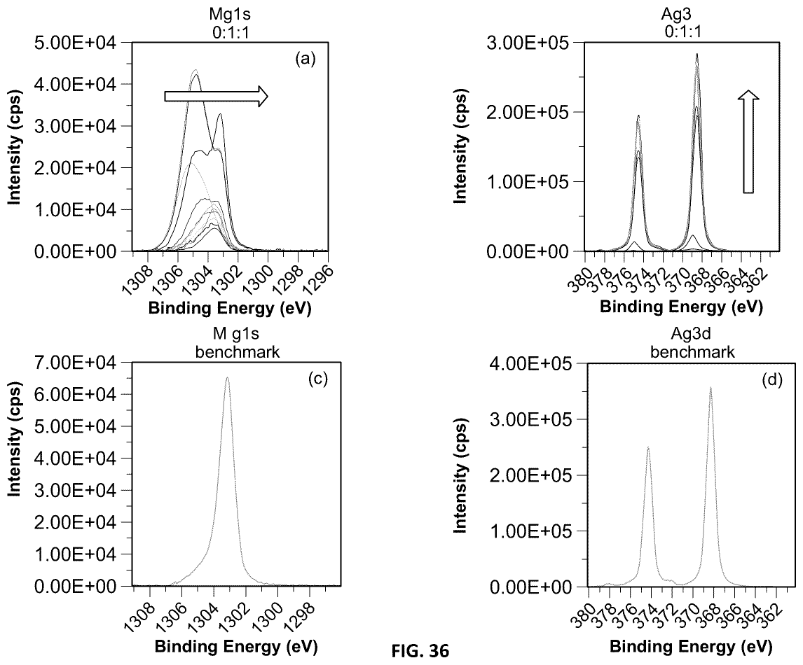

As shown in the previous sections, ternary composition 7:1:0.125 outperformed not only pure Li, but more importantly, binary combinations of Li:Mg and Ag:Mg components. Such performance was attributed to the presence and distribution of beneficial Li₂AgMg and AgMg phases throughout the film. A question remained to the homogeneity of these phases and elements throughout the thickness of the deposited films. As shown in FIG. 34, XPS depth analysis was utilized to evaluate the homogeneity of the codeposited 7:1:0.125 sample, where the binding energy (BE) signals from Ag and Mg components remained unshifted throughout the depth of the film analyzed, relative to BEs observed towards the surface and the substrate adjacent region of the film (up until approximately 15000 seconds of total sputtering or approximately 7500 nm at a calculated rate of 0.5 nm/sec). The BEs observed for Ag (˜368.8 eV) are slightly blue shifted from benchmark Ag signals observed for pure Ag metal (˜368.2 eV, FIG. 36) as well as those recorded in literature (˜368.2 eV). The BEs observed for Mg (˜1303 eV) agrees with benchmark Mg signals observed for pure Mg metal (˜1303.1 eV, FIG. 36) as well as those recorded in literature (˜1303 eV). Unlike the observed Ag and Mg signals, the initial Li1s BE is shown to be continuously red shifted within the first ˜500 seconds relative to the more stabilized signal revealed with depth. After additional sputtering, a shift towards BEs that approximated Li metal with was observed (55 eV). This variation of the Li1s signal may be due to surface contaminants containing adventitious carbon and other elements found at relatively higher Li1s binding energies. As shown in FIG. 35, atomic %'s for Li, Mg, and Ag components remain relatively constant throughout the film after ˜5000 total seconds. In summary, the elemental distribution of the elements was relatively invariant as a function of depth except a slight concentration enhancement of Li on the surface possibly induced by reaction with glovebox contaminants suggesting the distribution of the ternary and binary phases are relatively uniform through the depth of the material.

Additionally, as shown in FIG. 36, XPS depth analysis was also performed for a codeposited binary thin film (0:1:1). BEs were observed for Ag and Mg components from the surface to the substrate adjacent region (approximately 6180 total seconds of sputtering or approximately 3090 nm at a calculated rate of 0.5 nm/sec). As shown, consistent Ag3d BEs revealed with depth appear to be red shifted compared to those observed for the 7:1:0.125 composition with depth, 368.5 eV vs 368.8 eV respectively The Mg1s signal, however, is observed to be relatively blue shifted compared to the benchmark Mg BE due to the presence of potential surface oxides, where after approximately 1,110 seconds of sputtering a consistent red shifted BE is observed. This Mg BE (1303.6 eV) is blue shifted compared to the signal observed within the 7:1:0.125 ternary composition (1303.4 eV).

FIG. 34 shows XPS depth analysis of codeposited 7:1:0.125 thin film composition featuring Li1s (a), Mg1s (b), and Ag3d (c) signals. Blue arrows indicate progression of signal with total sputtering time.

FIG. 35 shows atomic % distribution with sputtering of the observed Li1s, Mg1s, and Ag3d signals within the 7:1:0.125 composition.

FIG. 36 shows XPS depth analysis of codeposited 0:1:1 thin film composition featuring Mg1s (a) and Ag3d (b) signals, where benchmark Mg and dg signals are found in figures (c) and (d) respectively. Blue arrows indicate progression of signal with total sputtering time.

### 3. Improvement of 7:1:0.125 Thin Film Performance Using Optimized FOS Based Electrolyte

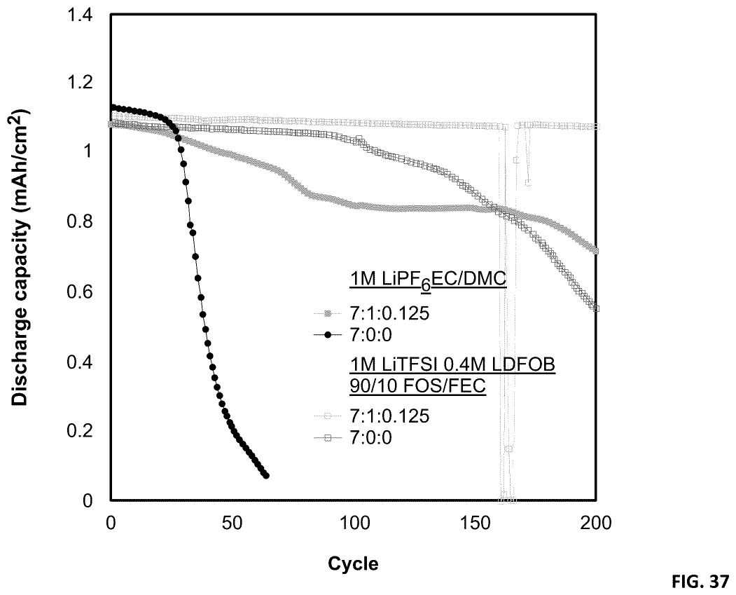

The performance of the 7:1:0.125 composition vs LCO was further improved utilizing a dual salt fluoroganosiyl (FOS) based electrolyte that has been previously shown to stabilize Li-metal plating. As shown in FIG. 37, the use of the FOS based electrolyte composition significantly improves capacity retention and cyclability for both 7:1:0.125 and 7:0:0 composition, relative to their performance with standard commercial electrolyte 1M LiPF₆ EC/DMC. Additionally, as shown in Table 15, significant improvement in first cycle irreversible loss is also observed for both the 7:1:0.125 and 7:0:0 compositions with the utilization of the optimized FOS based electrolyte.

FIG. 37 shows discharge capacity (mAh/cm²) observed to cycle 200 for Li:Mg:Ag thin films vs LCO cells. Li:Mg:Ag thin film negative electrode compositions shown here include ratios of 7:1:0.125 and 7:0:0, where all Li containing compositions contain the same amount of Li. The above thin film compositions are shown utilizing standard electrolyte 1M LiPF₆ EC/DMC (yellow (7:1:0.125), black (7:0:0)) and optimized composition 1M LiTFSI 0.4M LDFOB 90/10 FOS/FEC (red (7:1:0.125), grey (7:0:0)).

TABLE 15
First cycle % irreversible loss for Li:Mg:Ag compositions
7:1:0.125 and 7:0:0 vs LCO utilizing standard commercial
electrolyte 1M LiPF₆ EC/DMC and optimized electrolyte
1M LiTFSI 0.4M LDFOB 90/10 FOS/FEC.
Table 15. First cycle % irreversible loss for Li:Mg:Ag
compositions utilizing standard vs optimized electrolyte

| | | % irreversible |
|---|---|---|
| Electrolyte | Composition | loss |
| 1M LiPF₆ | 7:1:0.125 (27c) | 2.38 |
| EC/DMC | 7:0:0 (10) | 3.35 |
| 1M LiTFSI 0.4M | 7:1:0.125 (27c) | 1.95 |
| LDFOB | 7:0:0 (10) | 1.85 |
| 90/10 FOS/FEC | | |

4. Ex-Situ XRD Evaluation of MgAg to Li₂AgMg Transformation with Lithiation

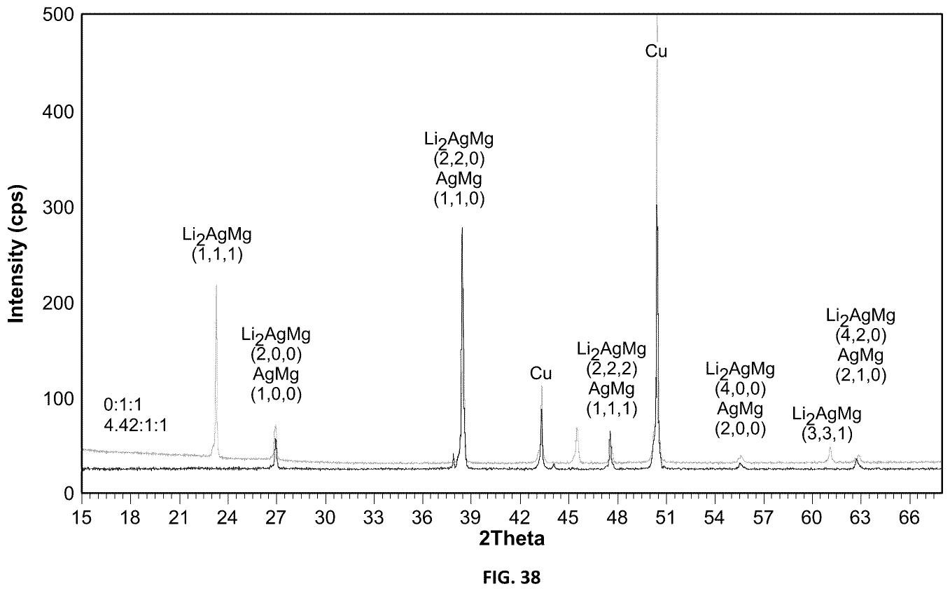

As shown, the binary MgAg and Li₂AgMg phases are related both structurally and functionally, as physical XRD analysis has revealed that some amount of binary phase aids in electrochemical performance, especially in the Li-ion configuration vs LCO where Li is added to the negative electrode. With the binary phase being related to the ternary structurally, there is a question of whether the binary transforms into the ternary structure upon lithiation. A binary Ag:Mg film was lithiated to Li x=4.42 and removed to examine by ex-situ XRD. As shown in FIG. 38, lithiation of a binary Mg:Ag composition (0:1:1) resulted in the formation of the ternary Li₂AgMg phase, as indicated by the appearance of the superstructure (1,1,1) Li₂AgMg Bragg reflection, and the (331) reflection. Rietveld analysis of these spectra has revealed the AgMg and Li₂AgMg lattice parameters to be 3.311 Å 6.638 Å, respectively and consistent with ICDD standards. In summary, the XRD data clearly supported the direct transformation of the AgMg binary into Li₂AgMg ternary upon electrochemical lithiation.

FIG. 38 shows ex-situ XRD evaluation of binary composition 0:1:1 (blue) and electrochemically lithiated binary 4.42:1:1 (red) compositions.

### 5. Structural Evolution of the 7:1:0.125 Ternary Upon Electrochemical Lithiation: Ex-Situ XRD

Lithiation of the ternary composition of 7:1:0.125 to an addition Lix=4.42, as was performed for the aforementioned 0:1:1 study, revealed a similar, but additional formation of the ternary phase. The presence of both ternary Li₂AgMg and binary MgAg components at the maximum lithiated level for Li ion cell configurations suggested that both components may play aid in electrochemical performance, where little dimensional change of the ternary phase is observed as well as no 2-phase development with lithiation. Rietveld analysis of these spectra reveal the Li, AgMg and Li₂AgMg components of the pristine unlithiated 7:1:0.125 composition (3.492, 3.328, and 6.658 A respectively) to be similar to that of the lithiated 11.42:1:0.125 composition (3.492, 3.329, and 6.658 A respectively).

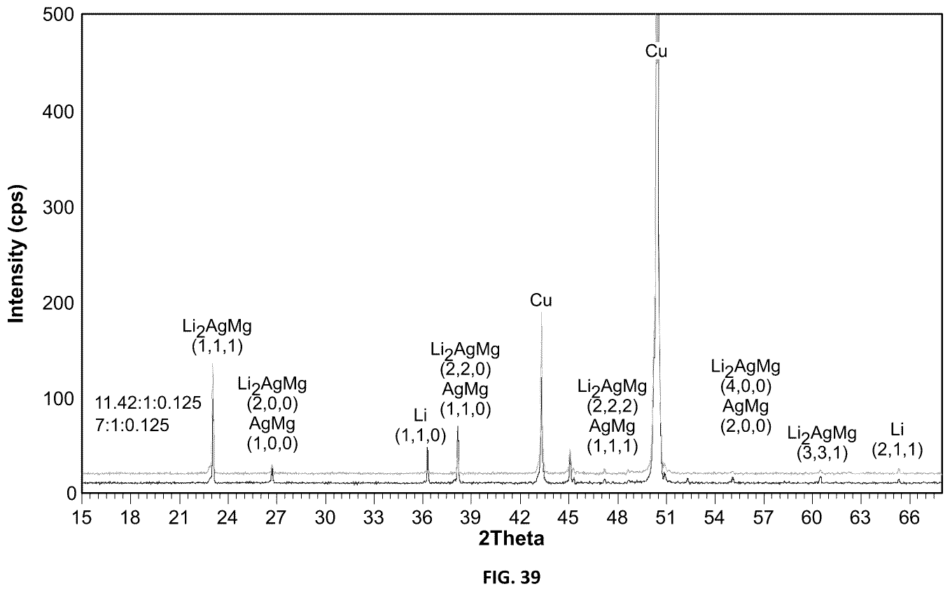

FIG. 39 shows ex-situ XRD evaluation of ternary composition 7:1:0.125 (blue) and electrochemically lithiated 11.42:1:0.125 (red) composition.

The present invention includes the following embodiments:

Embodiment 1. A battery, comprising:
a housing;
a positive electrode in the housing;
a negative electrode in the housing,
   wherein the negative electrode comprises an alloy,
      wherein the alloy comprises lithium, magnesium, and silver; and
an electrolyte in the housing, the electrolyte configured to conduct ionic current between the positive electrode and the negative electrode.

Embodiment 2. The battery of Embodiment 1, wherein a material of the positive electrode does not include lithium in its atomic structure.

Embodiment 3. The battery of Embodiment 1, wherein a material of the positive electrode includes lithium in its atomic structure.

Embodiment 4. The battery of Embodiment 1, wherein a total weight percent of the lithium, magnesium, and silver in the alloy is at least 50% of a total weight of the alloy.

Embodiment 5. The battery of Embodiment 1, wherein a material of the negative electrode has a crystal structure as determined by XRD to be consistent with Li₂AgMg.

Embodiment 6. The battery of Embodiment 1, wherein a material of the negative electrode has a crystal structure as determined by XRD to be consistent with AgMg, wherein the lithium is added to form a ternary alloy comprising the lithium, magnesium, and silver during operation of the battery.

Embodiment 7. The battery of Embodiment 1, wherein the lithium is formed on the negative electrode during operation of the battery.

Embodiment 8. The battery of Embodiment 1, where lithium is deposited on the alloy during operation of the battery.

Embodiment 9. The battery of Embodiment 1, wherein the electrolyte comprises lithium.

Embodiment 10. The battery of Embodiment 1, wherein the negative electrode further comprises graphite.

Embodiment 11. The battery of Embodiment 1, wherein the positive electrode comprises at least one of a metal fluoride, sulfur, or metal sulfide.

Embodiment 12. The battery of Embodiment 1, wherein the positive electrode comprises at least one of a metal cobalt, nickel, iron, manganese.

Embodiment 13. The battery of Embodiment 1, wherein the positive electrode comprises iron fluoride or bismuth fluoride.

Embodiment 14. The battery of Embodiment 1, wherein the electrolyte does not include lithium.

Embodiment 15. The battery of Embodiment 1, wherein the electrolyte comprises fluoride.

Embodiment 16. The battery of Embodiment 1, wherein the alloy has a crystal structure represented by at least an X-ray diffraction peak corresponding to a d spacing of approximately 3.6 to 4.2 Angstroms.

Embodiment 17. The battery of Embodiment 16, wherein the d spacing is approximately 3.9 Angstroms.

Embodiment 18. The battery of Embodiment 17, wherein there is a X-ray diffraction peak corresponding to a d spacing of approximately 3.1 to 3.5 Angstroms

Embodiment 19. The battery of Embodiment 1, wherein the battery comprises a lithium-ion battery.

Embodiment 20. The battery of Embodiment 1, wherein the battery comprises a solid-state lithium battery.

Embodiment 21. The battery of Embodiment 1, wherein the electrolyte comprises a solid-state electrolyte.

Embodiment 22. The battery of Embodiment 1, wherein a composition of the alloy changes as a function of a thickness of the alloy.

Embodiment 23. A battery, comprising:
a housing;
a positive electrode in the housing;
a negative electrode in the housing;
a current collector in the housing;
a separator in the housing;
an electrolyte in the housing; and
an alloy, wherein the alloy comprises lithium, magnesium, and silver,
   wherein the alloy is on at least one of the negative electrode, the separator, and the current collector.

Embodiment 24. A method, comprising:
obtaining a housing;
disposing a positive electrode in the housing;
disposing a negative electrode in the housing;
depositing an alloy on the negative electrode, separator, or solid electrolyte,
   wherein the alloy comprises lithium, magnesium, and silver; and
disposing an electrolyte in the housing, the electrolyte configured to conduct current between the positive electrode and the negative electrode.

Embodiment 25. The method of Embodiment 24, wherein the depositing comprises depositing by physical vapor deposition.

Embodiment 26. The method of Embodiment 24, wherein the depositing comprises depositing a film.

Embodiment 27. The method of Embodiment 26, wherein the depositing comprises depositing the film by physical vapor deposition

Embodiment 28. The method of Embodiment 24, wherein the alloy has a crystal structure represented by at least an X-ray diffraction peak corresponding to a d spacing of approximately 3.6 to 4.2 Angstroms.

Embodiment 29. The method of Embodiment 24, wherein the positive electrode does not include lithium.

Embodiment 30. The method of Embodiment 24, wherein a total weight percent of the lithium, magnesium, and silver in the alloy is at least 50% of a total weight of the alloy.

Embodiment 31. The method of Embodiment 24, wherein the electrolyte comprises lithium.

Embodiment 32. The method of Embodiment 24, wherein the negative electrode further comprises graphite.

Embodiment 33. The method of Embodiment 24, wherein the positive electrode comprises iron fluoride or bismuth fluoride.

Embodiment 34. The method of Embodiment 24, wherein the electrolyte does not include lithium.

Embodiment 35. The method of Embodiment 24, wherein the electrolyte comprises fluoride.

Embodiment 36. The method of Embodiment 24, wherein the electrolyte does not include lithium.

What is claimed is:

1. A battery, comprising:
a housing;
a positive electrode in the housing;
a negative electrode in the housing,
wherein the negative electrode comprises an alloy,
wherein the alloy comprises lithium, magnesium, and silver at a period during charging or discharging of the battery; and
an electrolyte in the housing, the electrolyte configured to conduct ionic current between the positive electrode and the negative electrode.

2. The battery of claim 1, wherein a material of the positive electrode does not include lithium in its atomic structure as assembled in the housing.

3. The battery of claim 1, wherein a material of the positive electrode contains lithium in its atomic structure as assembled in the housing.

4. The battery of claim 1, wherein a total weight percent of the lithium, magnesium, and silver in the alloy is at least 50% of a total weight of the alloy.

5. The battery of claim 1, wherein a material of the negative electrode has a crystal structure as determined by XRD to be consistent with Li₂AgMg.

6. The battery of claim 1, wherein a material of at least a portion of the negative electrode has a crystal structure as determined by XRD to be consistent with AgMg, wherein the lithium is added to form a ternary alloy comprising the lithium, magnesium, and silver during the charging and discharging of the battery.

7. The battery of claim 1, wherein a material of at least a portion of the negative electrode comprises an alloy intermetallic of Mg and Ag, and wherein the lithium is added to form a ternary alloy comprising the lithium, magnesium, and silver during operation of the battery.

8. The battery of claim 1, wherein the electrolyte comprises lithium, fluoride, or a solid-state electrolyte.

9. The battery of claim 1, wherein the negative electrode comprises graphite.

10. The battery of claim 1, wherein the positive electrode comprises at least one of a metal fluoride, sulfur, or metal sulfide.

11. The battery of claim 1, wherein the positive electrode comprises at least one of a metal cobalt, nickel, iron, manganese.

12. The battery of claim 1, wherein the positive electrode comprises iron fluoride or bismuth fluoride.

13. The battery of claim 1, wherein the alloy has a crystal structure represented by at least an X-ray diffraction peak corresponding to a d spacing of approximately 3.6 to 4.2 Angstroms.

14. The battery of claim 13, wherein at least a second X-ray diffraction peak corresponds to a d spacing of approximately 3.1 to 3.5 Angstroms.

15. The battery of claim 1, wherein the battery comprises a lithium-ion battery or a solid-state lithium battery.

16. A battery, comprising:
a housing;
a positive electrode in the housing;
a negative electrode in the housing;
a current collector in the housing;
a separator in the housing;
an electrolyte in the housing; and
an alloy, wherein the alloy comprises lithium, magnesium, and silver,
wherein the alloy is on at least one of the negative electrode, the separator, and the current collector.

17. A method, comprising:
obtaining a housing;
disposing a positive electrode in the housing;
disposing a negative electrode in the housing;
depositing an alloy on the negative electrode, separator, or solid electrolyte,
wherein the alloy comprises lithium, magnesium, and silver; and
disposing an electrolyte in the housing, the electrolyte configured to conduct current between the positive electrode and the negative electrode.

18. The method of claim 17, wherein the depositing comprises depositing by physical vapor deposition.

19. The method of claim 17, wherein the alloy is an alloy film, and wherein the depositing comprises depositing the alloy film.

20. The method of claim 17, wherein a total weight percent of the lithium, magnesium, and silver in the alloy is at least 50% of a total weight of the alloy.
